(19) United States
(12) Patent Application Publication
(10) Pub. No.: US 2013/0014342 A1
(43) Pub. Date: Jan. 17, 2013

(54) HOVERING VACUUM CLEANERS AND COMPONENTS THEREOF

(71) Applicant: Jeremy Greer, Toronto (CA)

(72) Inventor: Anthony Greer, Toronto (CA)

(21) Appl. No.: 13/516,859

(22) PCT Filed: Dec. 16, 2010
(86) PCT No.: PCT/CA2010/001999

§ 371 Date: Aug. 28, 2012

(30) Foreign Application Priority Data
Dec. 17, 2009 (CA) 2,688800
Jul. 22, 2010 (CA) 2,710893

(51) Int. Cl. A47L 9/10; F16M 13/02; A47L 9/02; B01D 35/22; F16L 11/00

(52) U.S. Cl. 15/415.1; 55/508; 55/487; 55/485; 55/467; 138/118; 248/346.03; 248/346.03

(57) ABSTRACT

This invention relates to hovering vacuum cleaners and components therefor. Specifically improvements to the filtering system and air handling capabilities of the vacuum cleaner are disclosed.

### FIELD OF THE INVENTION

This invention relates to hovering vacuum cleaners and components therefor. Specifically improvements to the filtering system and air handling capabilities of the vacuum cleaner are disclosed.

### BACKGROUND TO THE INVENTION

There are many examples of hovering vacuums in the prior art. For example, Canadian Patent Application 2,247,721 teaches a vacuum cleaner including an exhaust port in the base thereof and defines a peripheral channel lying inside the rim of the base which alleges to provide for the air floatation lift of the vacuum cleaner with respect to the surface being cleaned. Such a cleaner is marketed unsuccessfully by AIRIDER which is advertised on the internet at www.aaavacuumcleaners.net. The AIRIDER system includes a bag-less design that allegedly has reduced clogging and increased performance. However, the AIRIDER system has never been successfully marketed in that unfortunately the design did not operate according to expectations. A part of the AIRIDER invention was as a consequence of the efforts of one of the inventors, Mailes. One of the issues for the design was creating a base with an air circuit therein as seen in FIG. 6 and also in FIG. 3 of the above-mentioned patent. It is submitted that this in fact was part of the reason for the lack of performance of the AIRIDER unit.

Canadian Patent Application 2,672,533 was filed by Mailes as well to allegedly improve the design of the base by splitting and providing two exhaust ports in the base to the bottom of the vacuum cleaner as seen in FIGS. 4 and 5 in an attempt to improve the stability of the unit. Within the alleged teachings of this patent application mere mention of the filtering system improvements is also discussed with respect to HEPA filtration as well as coarse filtering and secondary filtering and a general discussion of bag type filters without getting into exactly what is meant by bag type filters. With respect to filtration more precise aspects of the teachings thereof is provided in another publication by Mailes, PCT/GB2007/004577 which will be set out in more detail below.

As evidence with respect to the lack of success of the above-mentioned constructions it is submitted that the mere withdrawl of the AIRIDER unit from the market place is sufficient evidence (which will be discussed in more detail below), with respect to the lack of utility of the alleged designs of Rooney and Mailes above-mentioned.

Further within vacuum cleaner construction generally there has been an emphasis with respect to cyclonic action and multi-stage filtration systems, for example with the popularity of the Dyson unit found in today's marketplace.

For example, British Patent Application GB 2,246,717 teaches a vacuum cleaner containing coarse and fine filtering therein and a removable dust bin to collect the dust accumulated, as best seen in relation to the Figures therein and specifically FIG. 2C and FIG. 5.

Further PCT Application No. PCT/US2004/034841 teaches a vacuum cleaner with cyclonic dirt separation and a bottom discharge dirt cup with a cylindrical filter contained therein including a foam filter and a pleated filter.

U.S. Pat. No. 4,426,211 teaches a vacuum cleaner with integrated dust disposal as seen in FIGS. 3 and 4. The dust therefore is disposed of in a simple and clean manner from a dust collector from which it is easy to discharge the contents thereof. A primary filter is provided along with a secondary filter behind the primary filter so that the dust passing through the primary filter is passed into the secondary filter. The primary filter includes a coarse mesh for trapping relatively large dust and the secondary filter includes a finer mesh for trapping relatively small dust.

U.S. Pat. No. 6,948,212 teaches a centrifugal force generated by whirling of air in a vacuum cleaner which also includes a “pocket” type dust collecting apparatus of a large capacity so that air drawn into the unit will pass through the dust pocket filter which will then filter out the dust from the air as best seen in relation to FIGS. 2 and 3.

FIG. 6 of the '212 patent discloses and illustrates what is meant by the inventor when referring to a “pocket” type filter. Clearly what is meant in the disclosure of the '212 patent is that the pocket type filter has a frame and a dust pocket 430. The frame 410 is fixed in position and is connected with said pocket 430 on a connecting member 420. Therefore the alleged pocket filter of the '212 patent is in fact similar to a disposable bag type filter arrangement.

Referring now to U.S. Pat. No. 7,144,438 to Samsung there is taught a dust collecting container for a vacuum cleaner as best seen in relation to FIG. 1. Clearly the container 100 is sized and adapted to fit within the opening of the vacuum cleaner 10, as shown, including co-operative rails 11a and 11b in the vacuum cleaner and 12a and 12b which engage with the side grooves in the dust collecting container. A hose end is larger than the vacuum hose diameter and being somewhat bulbous or expanded and cylindrical in form and is inserted within an opening 10b of the vacuum cleaner housing. As best seen in FIGS. 2 and 3 the components of the filter are clearly seen including a pleated filter, sponge filters and pre-filters. The first filter in the container may be a mesh member while the second filter is a sponge. The third filter is a non-woven fabric and includes an outer frame and in fact appears to be pleated from the figures as well. Clearly these filters will therefore take out or remove from the air and contain dirt/dust of various sizes varying from large to small with the pleated filter providing more surface area for the finer particle filtering process.

Referring now to PCT Application No. PCT/GB2007/004577 to Mailes there is taught a filter assembly for a hovering vacuum cleaner which is mounted in a vacuum cleaner dust chamber. The filter assembly includes a HEPA filter 21, a pre-filter 3a and an intermediate filter 5 contained in position between the pre-filter 3a and the HEPA filter 21. Tabs are provided on the top of the filter housing to remove the pre-filter, which Applicant has found to be a charcoal filter in use with the AIRIDER product which is too fine for coarse filtering. The housing that maintains the alleged pre-filter 3a in position comprises a plastic grid which in itself also acts as a filter for the coarse material. The intermediate filter 5 also is found to be a fibrous material which essentially takes up the entire air space between the HEPA filter and the pre-filter as seen in FIG. 2. The results of tests therefore on such a filtration system has found that the AIRIDER vacuum cleaner unit would stop hovering after five (5) minutes and that after five (5) minutes the pre-filter was entirely fouled, the intermediate filter was fairly well soiled and that dirt had passed on to the pleated filter, which is the HEPA filter, which is totally undesirable and inefficient.

There therefore is a need for improvements to the filtration system of vacuum cleaners generally and to hovering vacuum cleaners specifically.

Another aspect of vacuum systems that are often addressed in patent literature is the actual vacuum hose or the hose cuff design. These can take many forms and include both pathways for air as well as electrical connections. Examples of such compound type hose connections are found in U.S. Pat. No. 7,390,206 which teaches a central vacuum system hose cuff which includes standard electric outlets to accommodate the electrical path presented through the vacuum hose. To assemble such a hose cuff, clearly a plastic type clam shell design is provided for the hose cuff so that all of the aspects of the hose may be included including electrical connections, etc.

U.S. Pat. No. 4,018,493 also teaches a vacuum cleaner hose end structure as best seen in relation to FIG. 2, which connects at one end to the vacuum cleaner and at the other end to the power nozzle attachment. Again electrical connections are provided conveniently through the actual hose design and particularly the nozzle end. As best seen in FIG. 9 the actual design of the interfitting components for the hose are illustrated.

A further example is found in U.S. Pat. No. 4,618,195 which teaches a hose coupling and the manufacture thereof for connecting to a canister style vacuum cleaner suction inlet. U.S. Pat. No. 4,188,081 also teaches a more complex vacuum cleaner hose assembly and method of making said assembly.

U.S. Pat. No. 3,928,715 also teaches such a vacuum cleaner hose assembly and method of making that assembly to incorporate electrical connections therewith which are embedded therein.

One of the first patents that teaches electrical connections through a hose is found in U.S. Pat. No. 2,524,522 as best seen in FIG. 5 which structurally in terms of electrical connections is relevant for the present invention and is therefore relied on as a teaching in the prior art, not that this disclosure is ever considered to affect the novelty and inventiveness of the present invention.

Referring to U.S. Pat. No. 4,811,450 corresponding to CA Patent 1,281,857 there is taught a vacuum cleaner with an improved auxiliary cleaning unit and hose. The vacuum cleaner nozzle attachment is adapted to receive an auxiliary cleaning hose as best seen in FIG. 1 and FIG. 6 which hose blocks the primary air channel to reroute air to the auxiliary hose. In doing this the auxiliary hose must be designed essentially the way it is shown, which is not well described in the '450 patent, but which appears to include half a nozzle end cut away to allow air to exit therefrom at an angle as best seen in FIG. 6. It appears that the end 12 of the nozzle is rounded and that air will smoothly enter into the fan and be carried to the air filtration system of the vacuum unit. No further discussion is available other than at column 6, line 30 of the patent onward where it states there is an accessory door 48 and it is adapted to receive the auxiliary hose 50 which includes a flange portion 52 which may be received in the first air channel means 30 for blocking suction air flow from the portion of the air channel 30 forward of flange 52. No other discussion of the nozzle end is discussed.

### Prior Construction Testing

The filter housing for the AIRIDER unit of the prior art fits into the vacuum cleaner dust bin and includes a housing and a cover for this housing that contains the filter system for AIRIDER. The cover for the housing includes two (2) plastic doors that are removably attached to the housing and when removed provides access to the rest of the filter system. Basically the housing attempts to establish an air space which doesn't work properly for the reasons that will follow.

The door or cover for the housing includes a plastic frame on the door and a filter behind the door which appears to be a charcoal filter which is too fine a material and filters out both coarse and the fine particles at the same point. This is not really logical for a filter system. Normally filters are included that filter out the coarse material first then an intermediate filter that filters out intermediate sized particles and then of course the finer filter. So the plastic door is in fact a grid which acts as a filter as well although it probably was never intended to be one. The carbon filter behind the door is too fine and normally gets plugged after 5 minutes of operation of the AIRIDER hover vacuum cleaner. Once the filter system is plugged the vacuum cleaner stops hovering, at the point were the filters are fouled. The fan selected for the AIRIDER has a 80 psi reading at the outset of operation with the filters being clean, which drops to 56 psi once the filters are fouled and the machine fails to hover. If operation is continued the fan would be starving for air and would eventually kick out. The motor then may potentially cause a fire. Within the housing for the filter of the AIRIDER unit and below the cover there is provided a so-called box filter as described in the prior art (004577 above-mentioned) which fits in the air space in the housing and is made essentially of fibrous material. However, this is a faulty design in that this so-called box filter plugs or totally obstructs the air path, which might allow circulation of that air otherwise. Within the air space therefore in the filter housing of the AIRIDER unit there is finally a HEPA filter which is a pleated filter and normally is a high efficiency particle extraction filter which filters out the finer particles. It is typically pleated to provide a greater surface area for filtering. This is similar to the structure of fine filters on furnace systems today. Unfortunately for the AIRIDER construction because of the illogical filter set up, the dirt reaches the HEPA filter very quickly and fouls the filtering media because of the design of this AIRIDER filter housing.

During the test period and at about 56 psi the AIRIDER unit failed to hover and was shut down to inspect the filter system. When the dust load goes right through the filter system and fouls the filters it creates a back pressure and eventually the unit will stop hovering after about five (5) minutes. Once the unit is open, that is the dust housing is removed which includes the air filter system, the outer doors, which are grid like, are plugged because although they are a plastic grid they act as filtering for the coarse material. The plastic grid includes underneath it a charcoal filter on the inner side of this door but it plugged and was literally blinded over and is a primary reason for this back pressure being created on the fan and the motor. The intermediate filter or the box filter is also penetrated with dust once the charcoal filter is removed, to observe the status of the intermediate filter. All the filter members were clean when the machine was first started to begin testing. Finally the HEPA filter was also fouled right through to the fan side of the pleated filter. The fan would have essentially kicked out as a result, if the test was not terminated.

The prior art outlined by the above examples are not in the least bit complete but merely are examples of prior art that is considered relevant by Applicant. There exists a need to improve the filtration system in a hovering vacuum cleaner to take advantage cyclonic action that would be available should the proper improvements be provided with a hovering vacuum cleaner. Generally the hovering vacuum cleaners in the prior art are somewhat inefficient and ineffective and in the case of the AIRIDER fail to perform what has been promised because of the poor design of the filtration system and the air handling path for hovering purposes. The logic of the filtration system as well of the AIRIDER unit with the finer filtering being conducted initially puts a load on the entire motor and fan and tends to draw dirt through the vacuum filter resulting in ineffective hovering.

It would therefore be advantageous to provide improvements to filtering systems that would extend the life of a hovering vacuum cleaner so that a vacuum cleaner is able hover as long as the limitations for air handling are achieved in spite of the amount of dust being accumulated in the filter.

Further it would be advantageous to provide a multi-stage air filtration system to be contained within a hovering vacuum cleaner which is designed logically to remove the coarse dust or dirt initially and subsequently at each stage remove finer and finer particles.

It would also be advantageous to provide unique improvements to the design of a vacuum hose and particularly the fitting at the end of a vacuum hose which when engaged with the opening in a dust bin will generate cyclonic action by the unique air flow exiting from said hose.

It is therefore a primary object of the invention to provide a compact, quiet and easily maneuvered hovering vacuum cleaner and the components therefore which is easy to use and is powerful to vacuum any surface being traversed.

It is a further object of the invention to provide a filtration system for a hovering vacuum cleaner which includes multiple stage filtering to filter the coarsest dirt or dust initially and the finer dust ultimately.

It is yet a further object of the invention within a dust filtration system to provide a pocket style filter which is oriented in such a way as to provide clearance about the perimeter thereof so as to allow circulation above and below said pocket filter and thereby provide improvements to air handling and dust handling efficiencies.

It is yet a further object of the invention to provide improvements to the design of a base of a hovering vacuum cleaner that includes a unique airway circuit which provides improvements to the hovering capability of a hovering vacuum cleaner as it traverses linoleum, tile, laminate, hardwood and carpeted floor surfaces.

It is yet a further object of the invention to provide a unique nozzle design for the end of a vacuum cleaner hose which turns the air as it enters the dust bin of a vacuum cleaner so as to create cyclonic action therein and utilize the dust bin of the vacuum cleaner as part of the dust separating process of an air filtration system.

It is yet a further object of the invention to provide a unique assembly of said vacuum cleaner hose at the nozzle fitting proximate the end thereof that turns the air in a different direction than the direction of extension of the axis of the vacuum hose.

Further and other objects of the invention will become apparent to one skilled in the art when considering the following summary of the invention and the more detailed description of the preferred embodiments illustrated herein.

### SUMMARY OF THE INVENTION

According to a primary aspect of the invention there is provided a nozzle disposed at an end of a section of vacuum cleaner hose, said nozzle for engaging the vacuum cleaner hose adjacent a hose cuff provided at one end of the hose, said nozzle being assembled with said cuff in use, said nozzle comprising a nozzle spout that directs air flow into a vacuum cleaner inlet substantially perpendicular to the direction of extension of said nozzle, said nozzle spout including a side oriented outlet and an end cap which change the direction of air travel exiting the vacuum cleaner hose from parallel to the direction of extension of said nozzle to substantially perpendicular to the extension of said nozzle proximate the nozzle spout, preferably said nozzle including the ability to swivel with respect to a vacuum cleaner hose so as to swivel when engaged with a vacuum cleaner in use and said nozzle also including a rubber nozzle collar adjacent said nozzle spout to seal the nozzle spout within an opening provided with the vacuum cleaner while retaining the ability to swivel freely.

In a preferred embodiment said rubber nozzle collar further comprises a sealing flange to further enhance the sealing ability of said collar with respect to the opening of said vacuum cleaner. Preferably said hose may further comprise an electrical plug integral therewith for providing power to a surface vacuuming apparatus.

In one embodiment air exiting said nozzle spout into said vacuum cleaner is turbulent in nature and as a result generates a cyclonic action in a dust chamber of said vacuum cleaner. Preferably said cyclonic action is a dual action cyclonic action, rotating in two different directions. Preferably the turbulent air flow proximate said nozzle spout also creates a third cyclonic action preferably disposed at substantially ninety degrees to the other dual action cyclonic action.

According to yet another aspect of the invention there is provided a vacuum cleaner hose comprising two ends, a first end for engaging a surface vacuuming apparatus, and a second end for engaging a vacuum cleaner, said second end of said vacuum cleaner hose terminating in a hose cuff and a preferably substantially cylindrical nozzle connected thereto and for engaging the opening in a dust bin of the vacuum cleaner, said nozzle including two extremities and having disposed proximate a first extremity a nozzle top section (preferably made from semi-rigid plastic resin) that engages the hose cuff disposed proximate the second end of the vacuum hose (preferably said hose cuff also being made from semi-rigid plastic resin) by the provision of a locking detent (preferably a groove) which engages and locks with a corresponding locking detent (preferably a ring) provided with the hose cuff permitting swiveling of the nozzle with respect to the hose cuff while securing the nozzle in position with respect to the vacuum hose, said nozzle including a nozzle spout at a second extremity thereof that engages the opening in the dust bin of the vacuum cleaner, and made of rigid material such as rigid plastic so as not to deflect under pressure, said nozzle top section and said nozzle spout having disposed there-between a nozzle collar preferably made from a thermoplastic elastomer for sealing the opening in the dust bin of said vacuum cleaner, preferably said nozzle collar also having a sealing flange disposed proximate the perimeter thereof adjacent said nozzle spout for sealing about the external perimeter of the dust bin opening, said nozzle spout including an air outlet disposed preferably substantially perpendicular to the axis of extension of said nozzle and also including an end cap portion proximate the end thereof which turns the direction of the air flow from the vacuum hose to a direction preferably substantially perpendicular to the axis of the nozzle, wherein air exiting said nozzle spout and passing into said dust bin of a vacuum cleaner generates cyclonic action in the dust bin, and preferably two cyclones rotating in opposite directions, as a result of turbulence created by turning the air exiting the nozzle spout of the vacuum hose.

According to yet another aspect of the invention there is provided a nozzle including two extremities and having disposed at the first extremity a nozzle top section (preferably made from semi-rigid plastic resin) that engages a hose cuff disposed proximate an end of a vacuum cleaner hose (preferably also made from semi-rigid plastic resin) said nozzle top section including a locking detent (preferably a groove) for engaging and locking with a corresponding locking detent (preferably a ring) provided with the hose cuff permitting swiveling of the nozzle with respect to the hose cuff of the vacuum cleaner hose while securing the nozzle in position with respect to the vacuum cleaner hose, said nozzle also including a nozzle spout proximate a second extremity thereof that engages an opening in a dust bin of the vacuum cleaner, said nozzle spout being made of rigid material such as rigid plastic so as not to deflect under pressure, said nozzle top section and said nozzle spout having disposed there-between a nozzle collar, preferably made from a thermoplastic elastomer, for sealing the opening in a dust bin of a vacuum cleaner, preferably said nozzle collar also having a sealing flange disposed proximate the perimeter thereof adjacent said nozzle spout for sealing about the external perimeter of the dust bin opening, said nozzle spout including an air outlet disposed preferably substantially perpendicular to the axis of extension of said nozzle and also includes an end cap portion at the end thereof which turns the direction of the air flow exiting the vacuum hose in a direction preferably substantially perpendicular to the axis of the nozzle, wherein air exiting said nozzle spout and passing into said dust bin of a vacuum cleaner generates cyclonic action in the dust bin, and preferably two cyclones rotating in opposite directions, as a result of turbulence created by turning the air exiting the nozzle spout of the vacuum cleaner hose.

According to yet another aspect of the invention there is provided a hovering vacuum cleaner comprising: a front and rear, a top and bottom, said vacuum cleaner having a base disposed proximate the bottom thereof, said base also having a top and bottom, said vacuum cleaner carrying a fan for moving air through said vacuum cleaner, said base having disposed proximate the bottom thereof an air handling circuit to permit the vacuum cleaner to hover over a surface being vacuumed on a cushion of air provided by said fan, said vacuum cleaner including an exhaust port passing through said base in communication with the air handling circuit, the air passing through the exhaust port to the air handling circuit, said air handling circuit being defined by a perimeter portion of said base extending around the perimeter of the bottom of said base, a central portion disposed proximate the middle of said base containing said exhaust port and disposed at a height above said perimeter portion of the bottom of said base, and a channel portion disposed between said perimeter portion and said central portion at a height above the central portion and at a predetermined channel depth, said channel portion substantially circumscribing said base but being discontinuous proximate the rear of said vacuum cleaner base, preferably whereat the central portion extends to the perimeter portion, wherein said air handling circuit is sized to substantially balance with the volume of air being moved by said fan through said vacuum cleaner and thus providing improved hovering capability of said vacuum cleaner as air passes from said exhaust port over said central portion and about said channel portion thus providing a cushion of air upon which said vacuum cleaner hovers.

According to yet another aspect of the invention there is provided a hovering vacuum cleaner comprising: a front and rear, a top and bottom, said vacuum cleaner having a base disposed at the bottom thereof, said base having a top and bottom and having installed on the top thereof a drive motor engaged with and powering a fan, said fan for moving air through said vacuum cleaner, said base having removably installed thereupon a dust bin, said dust bin having a removable dust filter assembly disposed therewith, said base also having disposed at the bottom thereof an air handling circuit to permit the vacuum cleaner to hover on a cushion of air provided by said fan, said vacuum cleaner having an inlet to the dust bin for passing on dust laden air to the dust filter assembly, and an exhaust port for air exiting from said fan following the dust filter assembly and disposed proximate the bottom of said base in communication with the air handling circuit, the air passing from the inlet, through the dust filter assembly, to the fan and through the exhaust port to the air handling circuit, said air handling circuit being defined by a perimeter portion of said base extending around the bottom of said base, a central portion of a second height in reference to said perimeter portion and the bottom of said base and containing said exhaust port, preferably disposed offset from the middle of said base at a height above said perimeter portion, said base also including a channel portion disposed between said perimeter portion and said central portion at a height above the central portion and at predetermined depth, said channel portion substantially circumscribing said base but being discontinuous proximate the rear of said vacuum cleaner base preferably whereat the central portion extends to the perimeter portion, wherein the volume of said air handling circuit is sized to substantially balance with the volume of air being moved by said fan through said vacuum cleaner and thus provides improved hovering capability of said vacuum cleaner as air passes from said exhaust port over said central portion and about said channel portion, thus providing a cushion of air upon which said vacuum cleaner hovers.

According to yet another aspect of the invention there is provided a hovering vacuum cleaner comprising a base having a top and a bottom, the vacuum cleaner including a drive unit for powering a fan assembly, said drive unit being fixed to the base proximate the top thereof, a dust collection chamber having an inlet and containing a filtering assembly for collecting dust during the course of normal vacuuming, a filter assembly being removably secured within said dust collection chamber adjacent said drive and said fan assembly, said base having disposed proximate the bottom thereof an air outlet allowing air to pass from the fan to the bottom of said base, a hovering channel disposed proximate the bottom of the base in communication with said air outlet and for providing the lift of said hovering vacuum cleaner, said hovering channel being disposed on the bottom of said base in an arch (preferably in a substantially horseshoe shape), said base also including a perimeter portion to help retain the air in said hovering channel, said dust collection chamber having the inlet being adapted to receive in use a nozzle end of a vacuum cleaner hose, said nozzle end having an air outlet disposed substantially perpendicular to the direction of extension of said nozzle and thereby discharging in use turbulent air directed toward said filtering unit, preferably so as to generate cyclonic action in said dust collection chamber and to wipe the surfaces of said filtering unit and to keep both the air and the dust in motion and thereby minimize the likelihood of said filter assembly fouling and thereby reducing the efficiency of said hovering vacuum cleaner.

According to yet another aspect of the invention there is provided a filter assembly for a vacuum cleaner (and preferably a hovering vacuum cleaner) comprising a bottom and side portions, a pocket filter support within said filter assembly for supporting a pocket filter, a pocket filter supported by supporting portions of said pocket filter support and preferably engaging flanges disposed proximate the top of said pocket filter, wherein the pocket filter is supported in an operating position by said pocket filter support while not allowing said pocket filter to touch the bottom and sides of the filter assembly thereby providing an air space disposed between the pocket filter and the filter assembly bottom and side portions to provide for circulation of air and allow the creation of turbulence in the air space to encourage any dust accumulating in the pocket filter to remain in motion and to ball up to thus improve the efficiency and effectiveness of the filter assembly of the vacuum cleaner. Preferably said pocket filter support has disposed proximate the top thereof, above said pocket filters, supplementary screens, which are in one embodiment 1/16 inch fiberglass mesh, to provide coarse filtering for the filter assembly, and preferably also having disposed after said pocket filters a HEPA filter member, preferably pleated, preferably said HEPA filter member having disposed proximate the exterior thereof adjacent said pocket filter a carbon charcoal filter to protect the HEPA filter member in use, the entire filter assembly being removably disposed within the dust collection chamber of the hovering vacuum cleaner.

According to yet another aspect of the invention there is provided a pocket filter support within a filter assembly for supporting a pocket filter, a pocket filter being supported in an operating position by said pocket filter support and preferably engaging with flanges disposed proximate the top of said pocket filter, said pocket filter support not permitting said pocket filter to touch the filter assembly and thereby providing an air space disposed between the pocket filter and the filter assembly to provide for circulation of air and allow the creation of turbulence in the air space to encourage any dust accumulating in the pocket filter to remain in motion and to ball up to thus improve the efficiency and effectiveness of the filter assembly.

In a preferred embodiment of the invention the provision of such a filter assembly abovementioned within the dust chamber of a hovering vacuum cleaner in conjunction with a unique nozzle with an air outlet disposed substantially perpendicular to the axis of said nozzle, provides a cyclonic action within the dust chamber which in operation keeps the air and the dust substantially in circulation in the dust chamber to reduce the load on the filter assembly. Further by wiping the filter assembly with circulating air and encouraging the dust to ball up in the dust chamber by the provision of cyclonic action therein vastly improves the life of said filter assembly and the lift of said hovering vacuum cleaner.

In another embodiment the channel disposed in the air handling circuit provided on the bottom of the base of the hovering vacuum cleaner is able to handle a predetermined air volume (or cubic feet per minute CFM of air) so that as air flows from the air exhaust to said channel the air will circulate in said channel and the central portion of said base to provide for the lift of the hovering vacuum cleaner with a minimum of air loss, the air flow of the fan within the vacuum cleaner being balanced with the volume of the air handling circuit.

In another embodiment of the invention the filter assembly is removably contained within the dust bin and oriented in the dust bin in use so that the air inlet of the dust bin of the filter assembly is oriented toward the filter assembly within said dust bin. Because of the efficiency in air filtering as described herein, air passing through said filter assembly is sufficiently clean so as to substantially maintain the integrity of both the drive motor and the fan and prevent fouling thereof yet provide quality air flow to the base which air quality is much improved over prior art hovering vacuum cleaners and which does not substantially allow particulate material to render hovering ineffective.

The nozzle spout is preferably made in such a way as to direct air into the dust bin substantially perpendicular to the air flow in the nozzle. In order to do this, the nozzle spout includes an opening disposed substantially perpendicular to the direction of travel of the air in the nozzle so as to turn the air proximate the nozzle spout and create turbulence when entering into the dust bin, the turbulence generating cyclonic action in the dust bin. It has been discovered that by rotation of the nozzle spout in one direction or the other with respect to the dust bin inlet, different cyclonic action patterns may be achieved within the dust bin. Preferably two counter revolving cyclones are generated in the dust bin by the use of said nozzle spout which normally creates turbulence at the outlet thereof within the dust bin. It also has been discovered that aside from cyclonic action near the inlet to the filter assembly that a third cyclonic action is achieved which wipes the inside surface of the dust bin and the filter assembly and which keeps dust in motion and suspended in the air which reduces the likelihood of the filter assembly clogging to a much greater extent than prior hovering vacuum cleaners.

As a result of all the improvements above-mentioned the hovering vacuum cleaner of the present invention represents quite an advance over prior known constructions as discussed in the background of the invention resulting in a product that will hover and easily glide over tile and linoleum floors without losing the ability to hover. Such a vacuum is easily maneuvered over various surfaces by the householder and achieves good pressure within the vacuum unit at all times regardless of how much dust/dirt has been vacuumed. Once the householder has finished the chore of vacuuming the dust bin may be removed, the filter assembly cleaned and reassembled within the dust bin, which is then inserted back into said hovering vacuum cleaner for the next use.

According to a primary aspect of the invention there is provided a nozzle disposed at an end of a section of vacuum cleaner hose, said nozzle for engaging the vacuum cleaner hose adjacent a preferred hose cuff provided at one end of the hose, said nozzle being engaged with said cuff in use, said nozzle comprising a nozzle spout that directs air flow into a vacuum cleaner inlet substantially perpendicular to the direction of extension of said nozzle, said nozzle spout including a side oriented outlet and an end cap which changes the direction of air travel exiting the vacuum cleaner hose from parallel to the direction of extension of said nozzle to substantially perpendicular to the extension of said nozzle proximate the nozzle spout, in one embodiment said nozzle including the ability to swivel with respect to a vacuum cleaner hose so as to swivel when engaged with a vacuum cleaner in use. Said nozzle also including a rubber nozzle collar adjacent said nozzle spout to seal the nozzle spout within an opening provided with the vacuum cleaner preferably while retaining the ability to swivel freely.

In a preferred embodiment said rubber nozzle collar further comprises a sealing flange to further enhance the sealing ability of said collar with respect to the opening of said vacuum cleaner. Preferably said hose may further comprise an electrical cord and receptacle integral therewith for providing power for a surface vacuuming apparatus.

In one embodiment air exiting said nozzle spout into said vacuum cleaner is turbulent in nature and as a result generates a cyclonic action in a dust chamber of said vacuum cleaner. Preferably said cyclonic action is a dual action cyclonic action, rotating in two different directions. Preferably the turbulent air flow proximate said nozzle spout also creates a third cyclonic action preferably disposed at substantially ninety degrees to the other dual action cyclonic action.

According to yet another aspect of the invention there is provided a vacuum cleaner hose comprising two ends, a first end for engaging a surface vacuuming apparatus, and a second end for engaging a vacuum cleaner, said second end of said vacuum cleaner hose terminating in a nozzle for engaging the opening in a dust bin of the vacuum cleaner, said nozzle including two extremities and having disposed proximate a first extremity a hose engaging section that engages the hose proximate a second end of the vacuum hose, said nozzle including a nozzle spout at a second extremity thereof that engages the opening in the dust bin of the vacuum cleaner, preferably which does not deflect under pressure, said hose engaging section and said nozzle spout having disposed there-between a nozzle collar for sealing the opening in the dust bin of said vacuum cleaner, said nozzle spout including an air outlet disposed substantially perpendicular to the axis of extension of said nozzle and also including an end cap portion proximate the end thereof which turns the direction of the air flow from the vacuum hose to a direction substantially perpendicular to the axis of the nozzle, wherein air exiting said nozzle spout and passing into said dust bin of a vacuum cleaner generates cyclonic action in the dust bin, as a result of turbulence created by turning the air exiting the nozzle spout of the vacuum hose.

According to yet another aspect of the invention there is provided a nozzle comprising two extremities and having disposed at the first extremity a hose engaging section proximate an end of a vacuum cleaner hose, said nozzle also including a nozzle spout proximate a second extremity thereof that engages an opening in a dust bin of a vacuum cleaner, said nozzle spout being preferably made of rigid material so as not to deflect under pressure, said hose engaging section and said nozzle spout having disposed therebetween a nozzle collar for sealing the opening in a dust bin of a vacuum cleaner, said nozzle collar also having a sealing flange disposed proximate the perimeter thereof adjacent said nozzle spout for sealing about the perimeter of the dust bin opening, said nozzle spout including an air outlet disposed substantially perpendicular to the axis of extension of said nozzle and also includes an end cap portion at the end thereof which turns the direction of the air flow exiting the vacuum hose in a direction substantially perpendicular to the axis of the nozzle, wherein air exiting said nozzle spout and passing into said dust bin of a vacuum cleaner generates cyclonic action in the dust bin, as a result of turbulence created by turning the air exiting the nozzle spout of the vacuum cleaner hose.

According to yet another aspect of the invention there is provided a hovering vacuum cleaner comprising: a front and rear, a top and bottom, said vacuum cleaner having a base disposed proximate the bottom thereof, said base also having a top and bottom, said vacuum cleaner carrying a fan for moving air through said vacuum cleaner, said base having disposed proximate the bottom thereof an air handling circuit to permit the vacuum cleaner to hover over a surface being vacuumed on a cushion of air provided by said fan, said vacuum cleaner including an exhaust port passing through said base and in communication with the fan and the air handling circuit, the air passing from the fan through the exhaust port to the air handling circuit, said air handling circuit being defined by a perimeter portion of said base extending around the perimeter of the bottom of said base, a central portion disposed proximate the middle of the bottom of said base containing said exhaust port and disposed at a height above said perimeter portion of the bottom of said base, and a channel portion disposed between said perimeter portion and said central portion at a height above the central portion and at a predetermined channel depth, said channel portion substantially circumscribing the bottom of said base but being discontinuous proximate the rear of said vacuum cleaner base whereat the central portion extends to the perimeter portion, wherein said air handling circuit is sized to substantially balance with the volume of air being moved by said fan through said vacuum cleaner and thus providing improved hovering capability of said vacuum cleaner as air passes from said exhaust port over said central portion and about said channel portion thus providing a cushion of air upon which said vacuum cleaner hovers.

According to yet another aspect of the invention there is provided a hovering vacuum cleaner comprising: a front and rear, a top and bottom, said vacuum cleaner having a base disposed at the bottom thereof, said base having a top and bottom and having installed on the top thereof a drive engaged with and powering a fan, said fan for moving air through said vacuum cleaner, said base having removably installed thereupon a dust bin, said dust bin being in communication with a dust filter assembly disposed on top of said base, said base also having disposed at the bottom thereof an air handling circuit to permit the vacuum cleaner to hover on a cushion of air provided by said fan, said vacuum cleaner having an inlet to the dust bin for passing on dust laden air to the dust filter assembly, and an exhaust port for air exiting from said fan following the dust filter assembly and disposed proximate the bottom of said base in communication with the air handling circuit, the air passing from the inlet, through the dust filter assembly, to the fan and through the exhaust port to the air handling circuit, said air handling circuit being defined by a perimeter portion of said base extending around the bottom of said base, a central portion of a second height in reference to said perimeter portion and the bottom of said base and containing said exhaust port, said base also including a channel portion disposed between said perimeter portion and said central portion at a height above the central portion and at predetermined depth, said channel portion substantially circumscribing said base but being discontinuous proximate the rear of said vacuum cleaner base, wherein the volume of said air handling circuit is sized to substantially balance with the volume of air being moved by said fan through said vacuum cleaner and thus provides improved hovering capability of said vacuum cleaner as air passes from said exhaust port over said central portion and about said channel portion, thus providing a cushion of air upon which said vacuum cleaner hovers.

According to yet another aspect of the invention there is provided a hovering vacuum cleaner comprising:
a base having a top and a bottom,
the vacuum cleaner including a drive unit for powering a fan assembly, said drive unit being fixed to the base proximate the top thereof,
a dust collection chamber having an inlet in communication with a filtering assembly for collecting dust during the course of normal vacuuming,
said base having disposed proximate the bottom thereof an air outlet allowing air to pass from the fan to the bottom of said base,
a hovering channel disposed proximate the bottom of the base in communication with said air outlet and for providing the lift of said hovering vacuum cleaner, said hovering channel being disposed on the bottom of said base in an arch,
said base also including a perimeter portion to help retain the air in said hovering channel,
said dust collection chamber having an inlet being adapted to receive in use a nozzle end of a vacuum cleaner hose, said nozzle end having an air outlet disposed substantially perpendicular to the direction of extension of said nozzle and thereby discharging in use turbulent air directed toward said filtering assembly so as to generate cyclonic action in said dust collection chamber and to wipe the surfaces of said filtering assembly and to keep both the air and the dust in motion and thereby minimize the likelihood of said filter assembly fouling and reducing the efficiency of said hovering vacuum cleaner.

According to yet another aspect of the invention there is provided a filter assembly for a vacuum cleaner comprising a pocket filter within said filter assembly, the pocket filter being supported by supporting portions of a pocket filter frame engaging flanges disposed with said pocket filter, wherein the pocket filter is supported in an operating position by said pocket filter frame while not allowing said pocket filter to touch the bottom and sides of the filter assembly thereby providing an air space disposed between the pocket filter and filter assembly bottom and side portions to provide for circulation of air and allow the creation of turbulence in the air space to encourage any dust accumulating in the pocket filter to remain in motion and to ball up and to thus improve the efficiency and effectiveness of the filter assembly of the vacuum cleaner.

In a preferred embodiment of the invention the provision of such a filter assembly abovementioned within the dust chamber of a hovering vacuum cleaner in conjunction with a unique nozzle with an air outlet disposed substantially perpendicular to the axis of said nozzle, provides a cyclonic action within the dust chamber which in operation keeps the air and the dust substantially in circulation in the dust chamber to reduce the load on the filter assembly. Further by wiping the filter assembly with circulating air and encouraging the dust to ball up in the dust chamber by the provision of cyclonic action therein vastly improves the life of said filter assembly and the lift of said hovering vacuum cleaner.

In another embodiment the channel disposed in the air handling circuit provided on the bottom of the base of the hovering vacuum cleaner is able to handle a predetermined air volume (or cubic feet per minute CFM of air) so that as air flows from the air exhaust to said channel, the air will circulate in said channel and the central portion of said base to provide for the lift of the hovering vacuum cleaner with a minimum of air loss, the air flow of the fan within the vacuum cleaner being balanced with the volume of the air handling circuit.

The nozzle spout is preferably made in such a way as to direct air into the dust bin substantially perpendicular to the air flow in the nozzle. In order to do this, the nozzle spout includes an opening disposed substantially perpendicular to the direction of travel of the air in the nozzle so as to turn the air proximate the nozzle spout and create turbulence when entering into the dust bin, the turbulence generating cyclonic action in the dust bin. Preferably two counter revolving cyclones are generated in the dust bin by the use of said nozzle spout which creates turbulence at the outlet thereof within the dust bin. Preferably a third cyclonic action is achieved which wipes the inside surface of the dust bin and the filter assembly and which keeps dust in motion and suspended in the air which reduces the likelihood of the filter assembly clogging to a much greater extent than prior hovering vacuum cleaners.

As a result of all the improvements above-mentioned the hovering vacuum cleaner of the present invention represents quite an advance over prior known constructions as discussed in the background of the invention resulting in a product that will hover and easily glide over tile and linoleum floors without losing the ability to hover. Such a vacuum is easily maneuvered over various surfaces by the householder and achieves good pressure within the vacuum unit at all times regardless of how much dust/dirt has been vacuumed.

According to another aspect of the invention there is provided a compact hovering vacuum cleaner comprising a top, bottom, front, and rear and having disposed proximate the bottom thereof a base including an air handling circuit, said vacuum including proximate the front thereof a removable dustbin for accumulating any dirt picked up by the vacuum cleaner, said vacuum also including a filter assembly adjacent to said removable dustbin within a housing for the compact vacuum, said filter assembly including;
(i) a pre-filter adjacent said removable dustbin,
(ii) a pocket filter adjacent said pre-filter and supported in position within the filter assembly in such a way so as to permit air circulation within and around the perimeter of the pocket filter,
(iii) a charcoal filter and a HEPA filter in series and disposed after said pocket filter but prior to a fan and drive assembly located near the rear of said vacuum cleaner,
   said base at the bottom thereof including a perimeter portion at a first height, a central portion at a second height above said perimeter portion and a generally horseshoe shaped channel portion there-between, said central portion including an air outlet in communication with the fan and said air handling circuit to direct filtered air to said channel of said base and thereby provides a curtain of air upon which said floating vacuum cleaner can easily move, said the compact vacuum performing effectively as a vacuum cleaner while hovering over various surface being cleaned.

Preferably said hovering vacuum cleaner includes an inlet to said dust bin utilized with a unique nozzle design for a vacuum hose as previously described so as to generate cyclonic action in the dustbin to maintain a swirling action of any dirt accumulated therein, and also to keep the air circulating within the pocket filter to permit dirt to ball up therein and thereby extend the time in between cleanouts of said filter assembly and emptying of said dust bin.

### BRIEF DESCRIPTION OF THE DRAWINGS

FIG. 1 is a schematic side view of a hovering vacuum cleaner and illustrated in a preferred embodiment of the invention.

FIG. 2 is a schematic front view of the dust bin 22 of the vacuum cleaner of FIG. 1 illustrating the air handling capability of the hovering vacuum cleaner of FIG. 1 and illustrated in a preferred embodiment of the invention.

FIG. 3 is a perspective view of the nozzle disposed at the end of a vacuum cleaner hose shown in FIGS. 1 and 2 and illustrated in a preferred embodiment of the invention.

FIG. 4 is a exploded perspective view of the components making up the nozzle end of the vacuum hose utilitized with the hovering vacuum cleaner and illustrated in a preferred embodiment of the invention.

FIG. 5 is a cut away side perspective view of the nozzle end of a vacuum hose shown in FIGS. 3 and 4 and illustrated in a preferred embodiment of the invention.

FIG. 6 is a side view of the dust bin 22 of the hovering vacuum cleaner of FIG. 1 illustrating how the nozzle end of the vacuum hose may be inserted to vary the amount of cyclonic action within the dust bin 22 and illustrated in a preferred embodiment of the invention.

FIG. 7 is a perspective view of the assembled filter assembly 40 of FIG. 1 illustrating the components thereof in perspective and shown in a preferred embodiment of the invention.

FIG. 8 is an exploded perspective view of the components of the filter assembly 40 of FIG. 7 illustrating the components thereof and the interelationships thereof and shown in a preferred embodiment of the invention.

FIG. 9 is a cut away side perspective view of the filter assembly of FIGS. 7 and 8 illustrating the handling of air and the circulation thereof to improve the filtration of the entire filter assembly and shown in a preferred embodiment of the invention.

FIG. 10 is a close-up cut away perspective view of one portion of the filter assembly of FIG. 9 illustrating the motion of the air within the pocket filter that creates the turbulent action therein and illustrated in a preferred embodiment of the invention.

FIG. 11 is a bottom view of the base of the hovering vacuum unit of FIG. 1 illustrating the path of the exhaust air proximate the bottom of the vacuum cleaner and illustrated in a preferred embodiment of the invention.

(from compact application)

FIG. 12 is a schematic side view of a hovering vacuum cleaner illustrated in a preferred embodiment of the invention.

FIG. 13 is a schematic front view of the dust bin of the vacuum cleaner of FIG. 12 illustrating the air handling capability of the hovering vacuum cleaner of FIG. 12 and illustrated in a preferred embodiment of the invention.

FIG. 14 is a schematic front view of the dust bin air flow of FIGS. 12 and 13 and illustrated in a preferred embodiment of the invention.

FIG. 15 is a perspective view of the nozzle end of the vacuum hose utilitized with the hovering vacuum cleaner and illustrated in a preferred embodiment of the invention.

FIG. 16 is a cut away side view of the nozzle end of a vacuum hose shown in FIG. 15 and illustrated in a preferred embodiment of the invention.

FIG. 17 is a side view of the hovering vacuum cleaner of FIG. 12 illustrating the filter assembly and illustrated in a preferred embodiment of the invention.

FIG. 18 is a side view of the filter assembly of FIG. 12 illustrating the pocket filter and shown in a preferred embodiment of the invention.

FIG. 19 is an exploded perspective view of the components of the filter assembly of FIG. 18 illustrating the components thereof and the interelationships thereof and shown in a preferred embodiment of the invention.

FIG. 20 is a side view of the filter assembly of FIGS. 18 and 19 illustrating the cartridge filer and shown in a preferred embodiment of the invention.

FIGS. 21 and 23 are a side views of the hovering vacuum cleaner of FIG. 12 illustrating the motion of the air within the unit that creates the turbulent action therein and illustrated in a preferred embodiment of the invention.

FIGS. 22 and 24 are bottom views of the base of the hovering vacuum unit of FIG. 12 illustrating the path of the exhaust air proximate the bottom of the vacuum cleaner and illustrated in a preferred embodiment of the invention.

### DETAILED DESCRIPTION OF THE PREFERRED EMBODIMENTS

Referring generally to the figures like parts are labeled identically in each figure. Further the figures provide detailed description and illustration of one embodiment of the present invention and the various aspects thereof. It is not intended that this material be considered as restrictive to only the preferred embodiment that is illustrated.

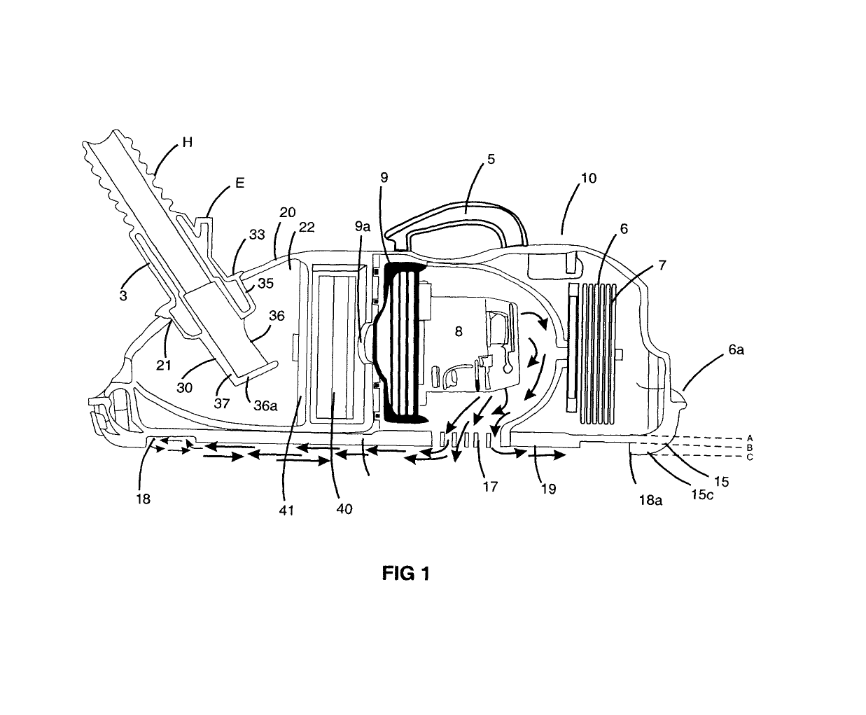

Referring now to FIG. 1 there is illustrated a side view of a hovering vacuum cleaner 10 which includes a handle 5 for carrying the vacuum cleaner from place to place when not in operation and provided on the top of the unit 10. Said vacuum cleaner 10 includes a dust bin 20 proximate the front thereof including an opening 21 within which in use the nozzle end 30 of a vacuum hose H is inserted. The dust bin 20 includes a space 22 therewithin wherein dust vacuumed from a surface via the hose H enters into that space 22 through opening 36 at the end of the nozzle portion 30. The nozzle opening 36 of the nozzle 30 is oriented perpendicular to the direction of air flow in the vacuum hose H. This aspect will be described hereinafter. The vacuum hose H includes a hose cuff 3 proximate the end thereof engaged with the nozzle portion 30 and also includes an electrical connection E should a powered surface cleaning element be utilized with the hovering vacuum cleaner. The nozzle end 30 includes a collar 35 which is flexible and which seals into the opening 21 of the dust bin 20 and further includes a sealing flange 33 about the perimeter of that collar 35 to prevent dust from escaping from the opening 21. The dust bin 20 also includes an air filter assembly 40 which will be described hereinafter to filter any air entering the space 22 within the dust bin 20 as it passes through the filter assembly 40 and through the opening 9a into and bypassing the fan 9 which is driven by typically a drive unit, an electric motor 8, so that the air passes around the fan and around the motor and passes out through an exhaust port 17 located in the base 15 of the vacuum 20. The electric cord 6 is accumulated on a reel 7 at the back end of the vacuum 10 as is well known in the art with the cord extending through the rear of vacuum cleaner 10 providing a section 6a as is also well known in the art. The electric motor typically may be supplied by Domel, d.d. or any other known supplier. (www.domel.com)

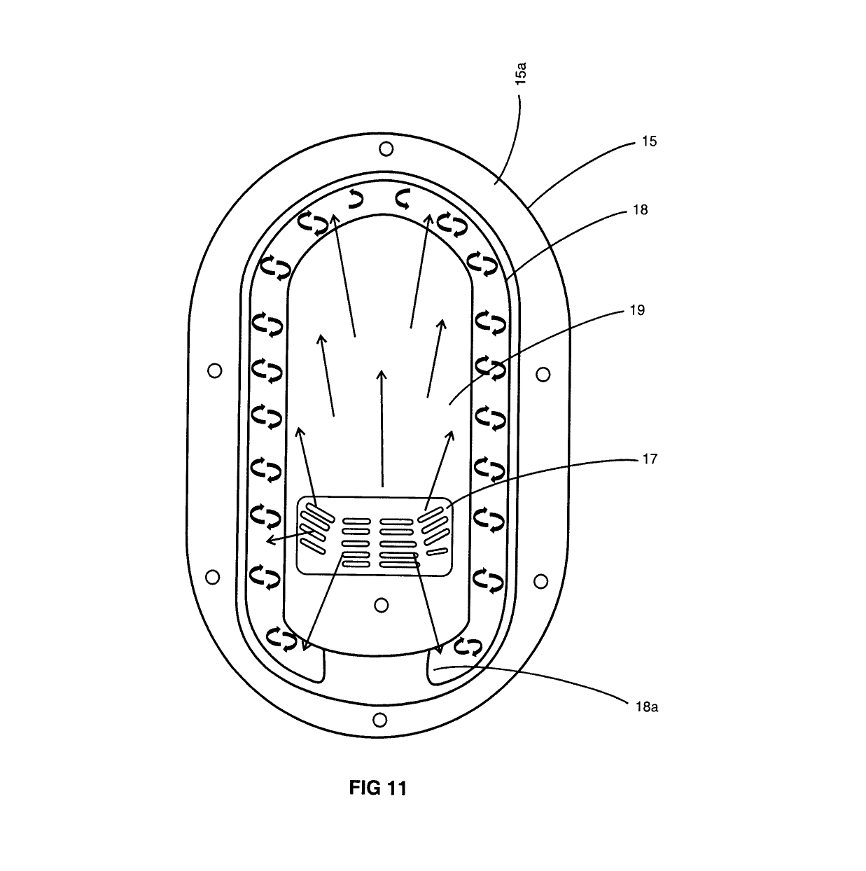

The base 15 of vacuum 10 includes as best seen in relation to FIG. 11 a unique pattern to improve the floatation of the vacuum cleaner on the surface being cleaned and includes a unique channel portion 18 extending about the base of FIG. 11 in a generally horseshoe pattern which will be described hereinafter. The channel portion 18 is surrounded by a perimeter skirt portion 15a and on the other side thereof by a central island like portion 19. The island portion 19 is at a different height B than the perimeter portion 15a at height C which is at a different height A as well in relation to the channel portion 18. The air therefore exiting from the exhaust port 17 as best seen in FIG. 11 passes over the island portion 19 and through the channel portion 18 thereby creating a cushion effect for hovering. The air handling circuit therefore as defined by said portion 19, 18 and 15a as best seen in FIG. 11 provides for the unique hovering ability and improvements to the hovering vacuum cleaner unit in that the channel portion 18 and the overall air handling circuit are sized to balance with the cubic feet per minute flow of air from the fan 9. Generally speaking the fan and drive motor are selected to provide 90 CFM (cubic feet per minute) as a minimum. The vacuum will not hover otherwise. Typically depending on the amperage rating of the circuit available to the motor, the fan should rotate at least 30,000 times per minute (RPM). The channel dimensions (depth and width) depends on the motor and fan size, but shall be balanced to the air flow capabilities thereof.

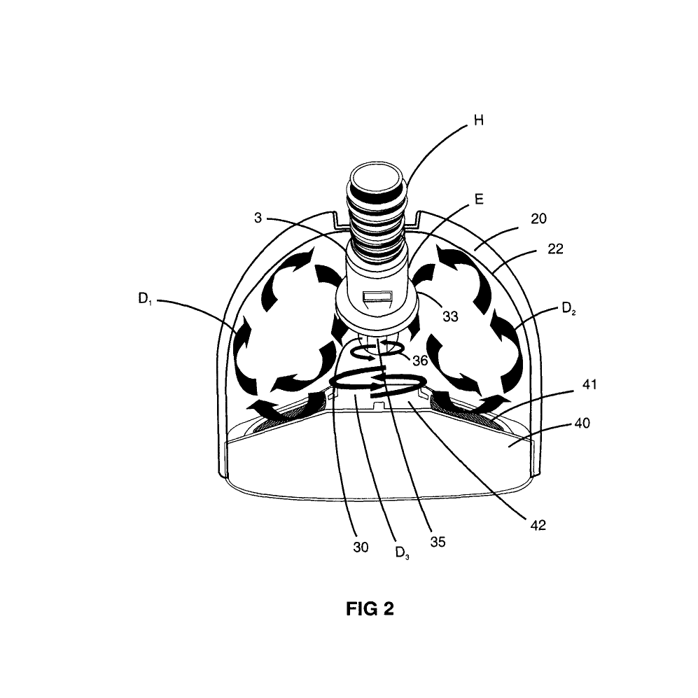

Referring now to FIG. 2 there is illustrated the dust bin 20 of FIG. 1 in schematic having an air space 22 disposed therein and an opening 21 therein within which a nozzle portion 30 of the vacuum hose H is inserted in use. Clearly as can be seen the nozzle portion 30 is engaged with the hose cuff 3 of the vacuum hose H. The nozzle portion 30 includes a sealing flange 33 about the flexible collar 35. Also provided within the dust bin space 22 is the air filter assembly 40 having a entry port proximate the top thereof which includes pre-filter portions 41 on the top thereof and a covering portion 42. The unique side exit for air of the nozzle portion 30 at 36 provides for turning of the air adjacent the air outlet 36 to the dust bin 20 and the resulting turbulent flow D3 as the air enters the dust bin 20 creating two cyclonic air currents D1 and D2 which keep the dirt or dust moving in a rotary fashion within the dust bin. This cyclonic action improves the air and dust handling capability of the hovering vacuum unit 10. As can be seen in FIG. 2 the rotation of the air in a cyclonic fashion pattern D1 and D2, tends to wipe the face of the pre-filter 41 continually and further wipe the face of the dust bin 20 continually as long as the vacuum unit is energized. As is apparent from FIG. 2 the cyclonic action D1 and D2 is created by the turbulent air flow D3 from nozzle opening 36 as the air moves toward filter inlets 41 and circulates back around again and again.

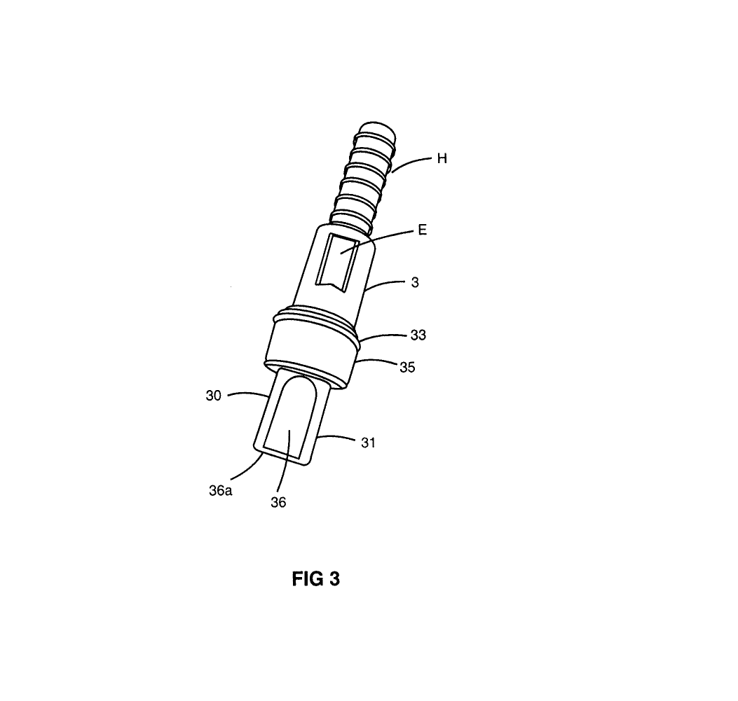

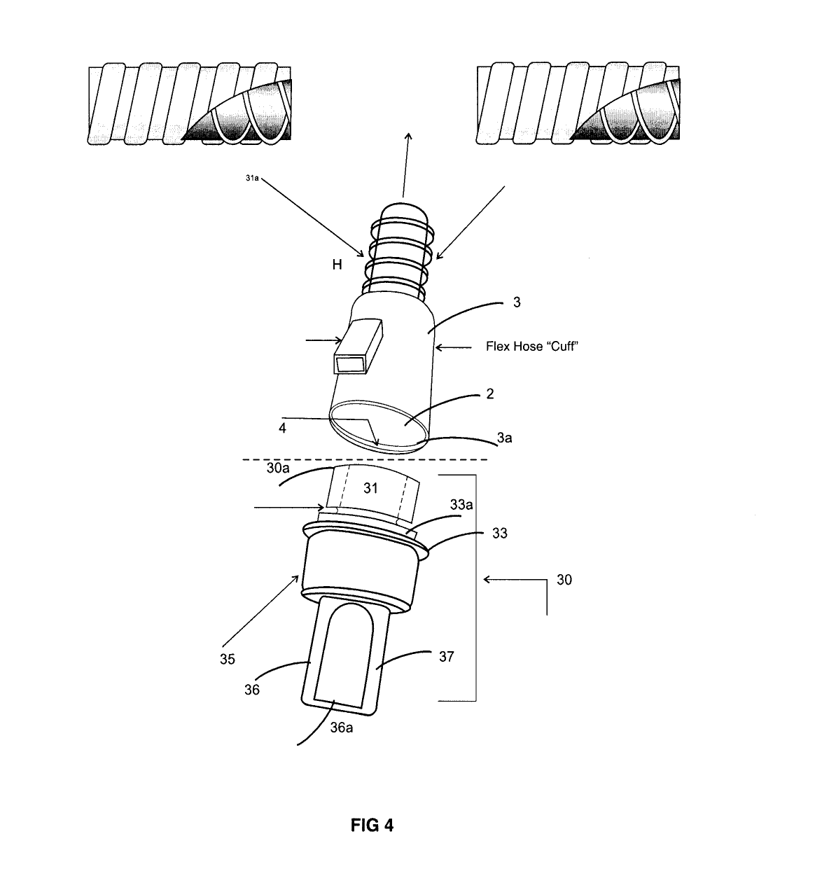

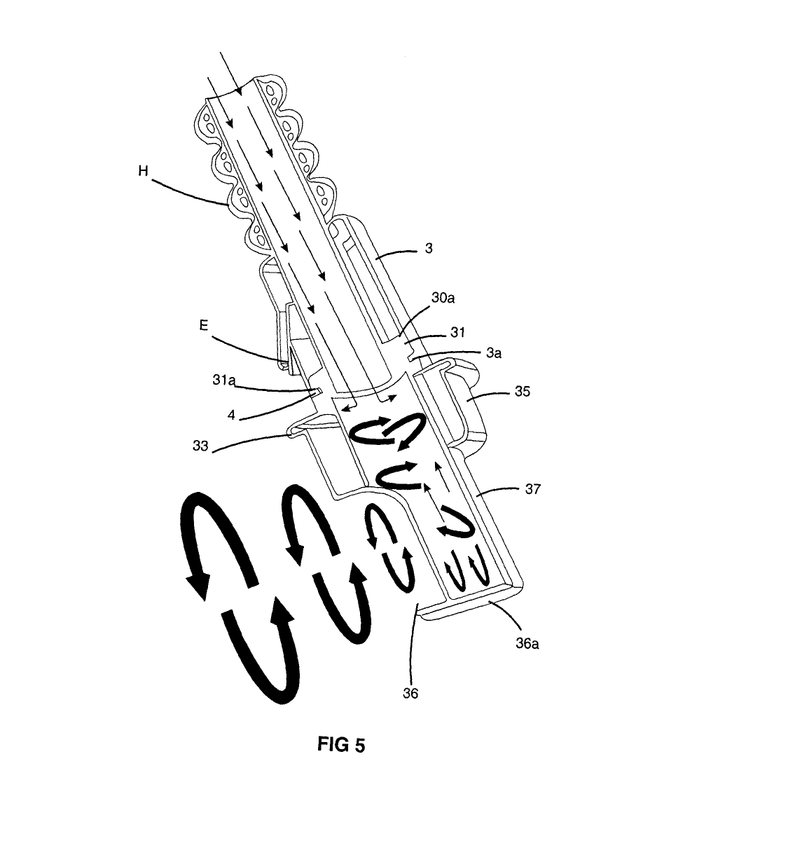

Referring now to FIGS. 3 and 4 there is illustrated the unique nozzle end of the vacuum hose H. The vacuum hose H is typical of the hose provided by a supplier with the exception of the fact that a flexible hose cuff 3 is provided near the end thereof which includes a cuff locking feature 4, in this case an upstanding rib, which when assembled with the portion 30 of the air hose nozzle will engage with the groove portion 31a to lock the locking feature 4, or rib portion, of the hose cuff when assembled as shown in FIG. 3, and yet allow for pivoting by 360 degrees of the hose in relation to the nozzle when the nozzle 30 is inserted into the dust bin 20. The nozzle collar 35 is manufactured from thermo plastic elastomer with a schorr durometer hardness of 80 plus or minus 4. The cuff 3 will also be made from the same material so as to provide for flexibility in creating the joint between the two parts 30 and 3. The lead end 30a of the nozzle section 30 will normally during assembly be inserted into space 2 until such time as the locking groove 31a engages the rib 4 as best seen in FIG. 5, wherein rib portion 4 at the end of the hose cuff portion 3a engages the groove 31a of the nozzle collar. The end portion 37 is to be manufactured from ridged material that will stand up to and not collapse under the force of various air pressure volumes and differences available in the vacuum cleaner unit.

Referring to FIG. 5, by providing a unique joint between the hose cuff and the nozzle end assembly, air moving down the vacuum hose H toward the nozzle end 30, when it reaches the blank wall 36a of said nozzle, will abruptly turn and exit said nozzle part 36 substantially perpendicular to the direction of air flow along the length of the vacuum hose. As a result turbulence is in fact created adjacent the nozzle as the air enters the dust bin 20 of the vacuum cleaner 10. This nozzle therefore will generate the cyclonic action that was previously described in relation to FIG. 2. Typically the vacuum hose H has a smaller interior diameter than the nozzle end 30 which helps create turbulent air flow at the end of the nozzle 30 as it exits the nozzle as shown.

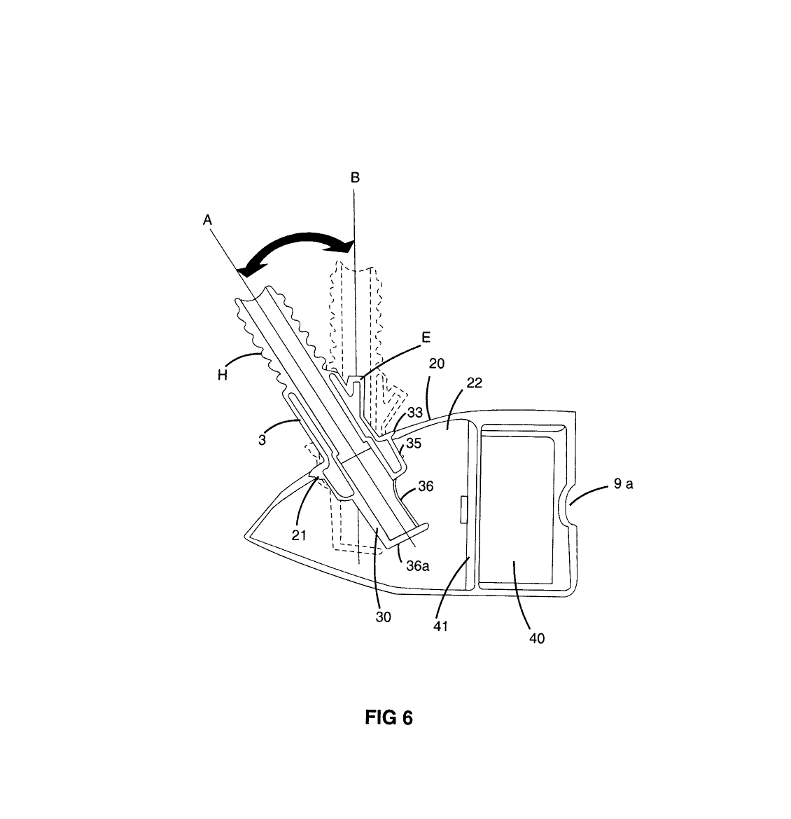

Referring now to FIG. 6 there is illustrated two positions that the nozzle end of the hose H may assume in order to create different patterns of cyclonic action within the dust bin 20. It is preferred that the vacuum hose H adopts position A as opposed to position B seen in FIG. 6 resulting in additional emphasis in generating cyclonic air patterns.

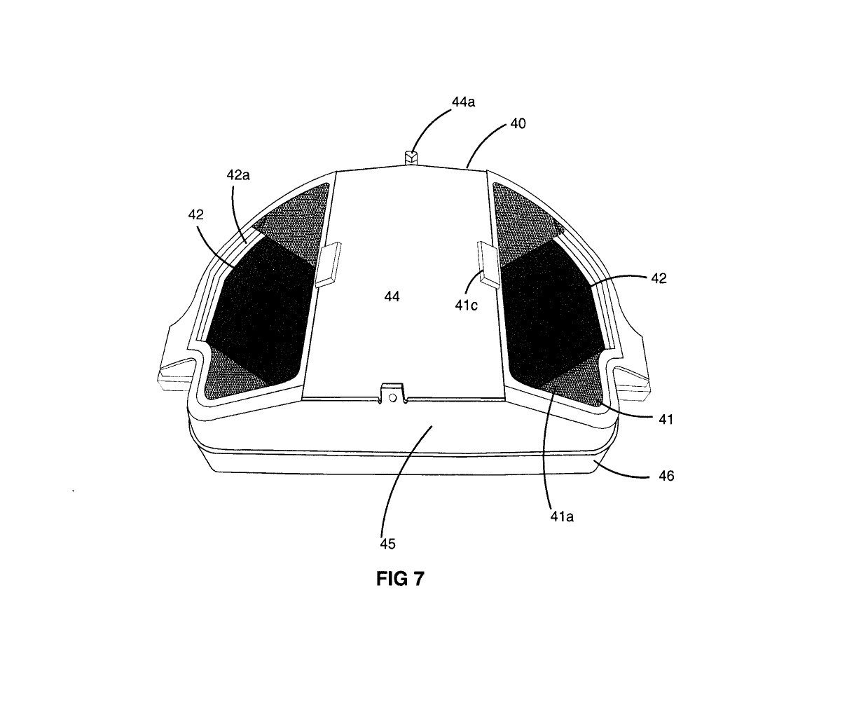

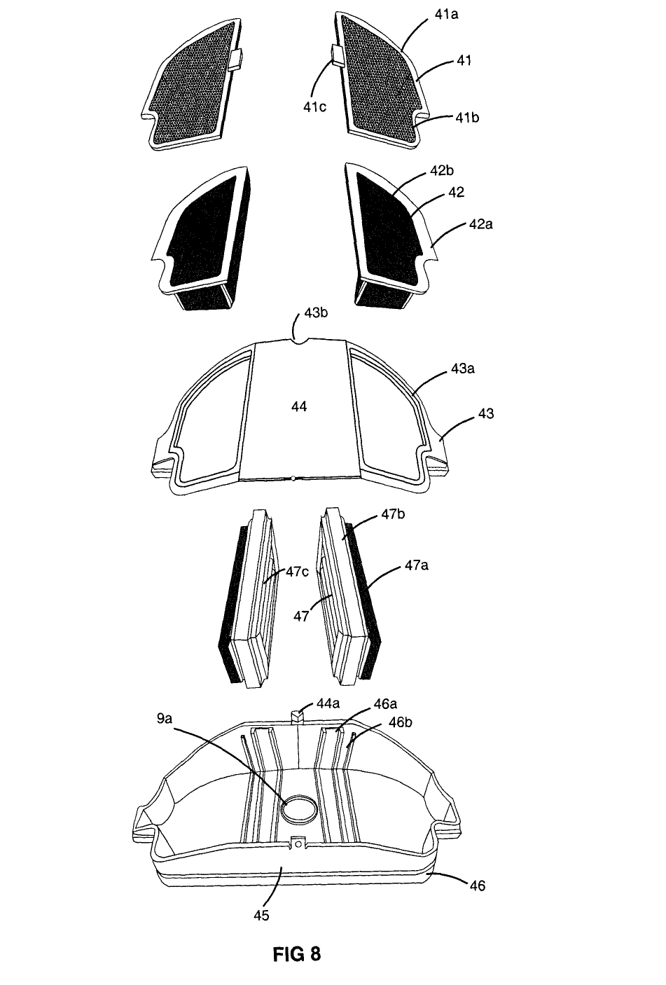

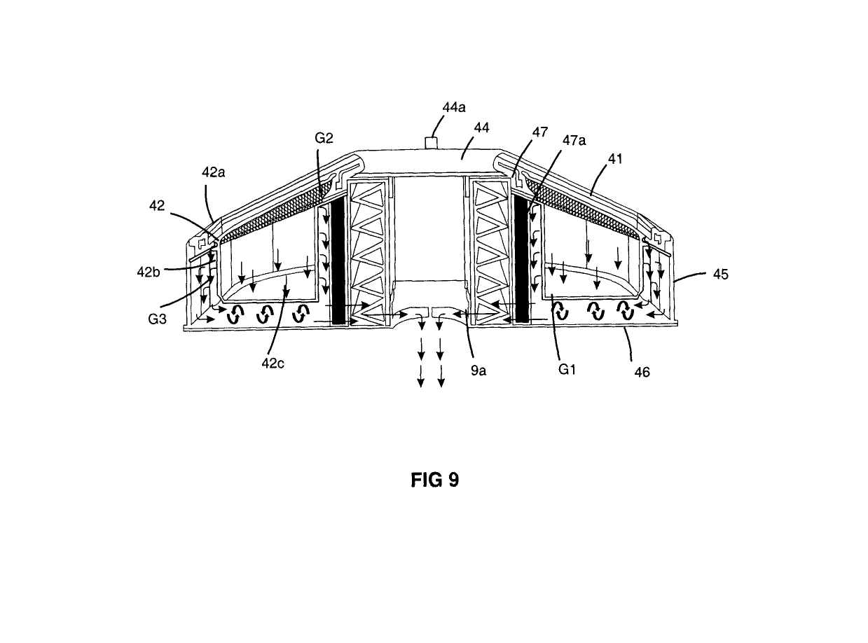

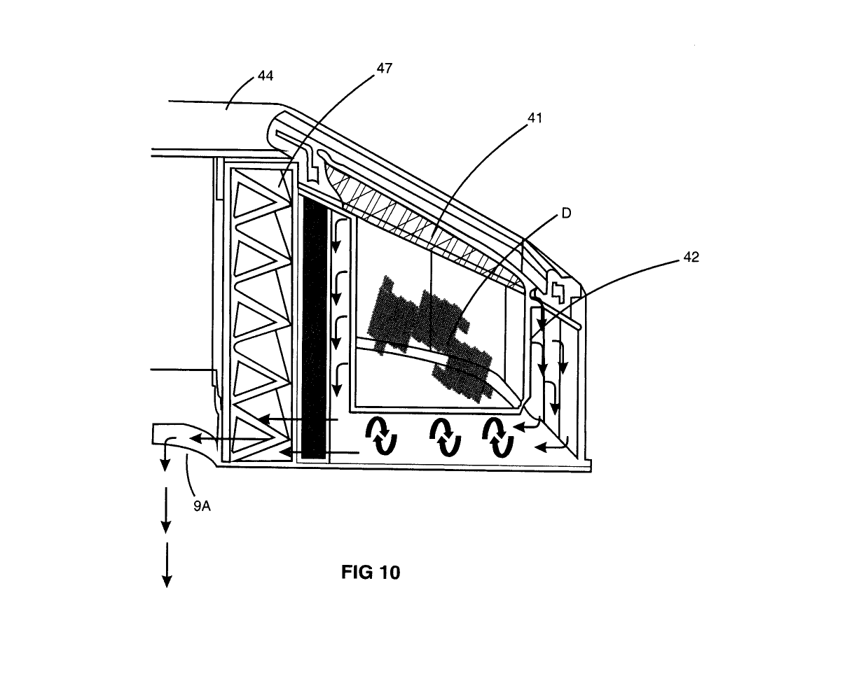

Referring now to FIG. 7 there is illustrated the air filter assembly 40 shown in FIG. 1 which includes a base 46 and a side portion 45 surrounding the base. Within the air filter assembly 40 is a cover portion 44 provided proximate the top thereof which may be removed from the air filter assembly 40 by disconnecting the top 44 from the housing and side parts 45 via the tab portions 44a. The top of the air filter assembly therefore includes pre-filter portions 41, typically 1/16 inch fiberglass screening, which is removed from the housing by operation of tab portions 41c as best seen in relation to FIG. 8. The air filter assembly 40 therefore includes the base portion 46, integral with the side portions 45. The base 46 includes the opening port 9a which allows air to pass from the dust bin space 22 into the fan portion 9 through port 9a. Retaining parts 46a and 46b are disposed in the bottom of the filter assembly. The sides 46 and 45 of the filter assembly 40 once assembled carries the HEPA filter portion 47, which includes pleated portions 47c. The base engaging portions 47b at grooves 46a and 46b for the pleated HEPA filter and the charcoal filter 47a respectively. Portion 44 with flange portions 43a is used to support the pocket filter portions 42 with flange portions 42a resting against flange portions 43a to secure the pocket filter 42 in position as will be described hereinafter in relation to FIG. 9.

Referring now to FIG. 9 it can be seen that the pocket filter 42 does not extend and touch the bottom 46 of filter assembly 40 but establishes an air space between the sides 45 and the pocket filters 42. The side portions 42b of the pocket filter 42 therefore provides between the outside portion 45 of the filter assembly and side portions 42b, a space within which air currents G1, G2 and G3 are generated in the gap portions between those parts. The constant circulation therefore in the spaces G1, G2 and G3 allows for turbulence and the rolling of any dirt, contained with the pocket filter as best seen in relation to FIG. 11. The dirt therefore rolls over and over and accumulates upon itself into balls which makes filtering of the dirt contained in the air much easier. This is similar to the action that takes place in the dust bin 22 and further enhances the filtering ability of the vacuum cleaner 10. Any air therefore passing through the pre-filters 41 into the pocket filters 42 through the charcoal filters 47a only through the HEPA filter 47 will pass through port 9a in the housing and to the fan 9 and subsequently through the exhaust port 17 to the air handling circuit previously described. As best seen in FIG. 11 the dirt therefore will ball up and roll over upon itself D and enhance the filtering ability of the components of the filter assembly 40. It is important to note that the pre-filter 41 does not clog as was the case with the prior art filter construction in that the pre-filter is only provided to do pre-filtering and to maintain the coarse material within the dust bin 20 as it rolls over within the dust bin space 22 by the cyclonic action created by the unique nozzle portion 30 of the vacuum hose H. The pocket filter portions 42 are designed for predetermined air flow as described previously herein and therefore are designed in such a way as to further enhance the filtering capability of the air handling system and the air filter assembly 40 by not only filtering by the use of a filter media, of which the pocket filter 42 is comprised, but also by the rolling action of the dirt D within the pocket filter 42 which enhances the filtering capability of the filter assembly 40. Final filtering is accomplished by the charcoal filter and the HEPA filter which is pleated 47 and 47a with a charcoal filter providing fine filtering to prevent fouling of the HEPA filter unless in the extreme case if the air is heavily loaded with very fine particulate material as might be the case at a construction site.

Referring to FIGS. 1 and 11 together in concert clearly it can be seen that the unique construction of the base provides for an air circuit from the exhaust port 17 around a center island portion 15 in the base to the channel portion 18, the base surrounded by the perimeter portion 15a and the base 15. It is noted that the channel portion 18 has a discontinuity adjacent the end 18a thereof which discontinuity includes the extension of the center island portion to the rim portion 19 to 15a. Air will therefore travel from the exhaust port along the island portion which has a different height than then the perimeter portion and subsequently to the channel 18 which has a further different height to allow a unique cushion of air to be provided upon which the vacuum 10 may hover. As previously mentioned the air handling circuit should be balanced with the fan speed and be provided with at least 90 CFM of air to permit hovering.

The improvements that this inventor has made to the vacuum cleaner construction provides a much improved filter system that provides for air circulation within the air filter housing. The outer member or media 41 is a fibreglass screen having the fineness of 1/16 inch grid. Grid doors have therefore been eliminated. These fibreglass screens 41 fit over a cage which connects to the bottom 46 of the filter housing 40 and this cage carries in use a hanging filter bag or pocket filter 42 which has a free type shape looking somewhat like a sack. The important point is that the pocket filter 42 is made from 220 CFM material which is surrounded by peripheral flange that allows it to be secured in the cage and to suspend therefrom. An important point here is that the assembly suspends the hanging pocket filter bags to a point where they do not touch the bottom 46 of the assembly 40 which allows for an air clearance and air circulation when the fan is operating. Dirt is therefore collected in these pocket filters 42 and when assembled the air housing provides air circulation in somewhat of a turbulent manner below the pockets causing the dust to roll over and ball up which further enhances filtering capability. The intent is to keep the dust suspended and moving in the filter system so that it does not clog up any of the filters. A HEPA filter is provided as a final filter for fine particles to keep them from going into the motor and the fan. The HEPA filter is specified as good for 475 CFM.

One of the attributes of the improved system includes the novel nozzle 30 which was described above along with the filter construction and the operation of the unit in concert with these unique nozzle 30 provides cyclonic action in operation, generated in the dust chamber 22 along with some turbulence as a result of the nozzle 30 that directly creates the cyclonic action. The nozzle 30 extends well into the dust chamber or dust bin 20 and as a result in fact there is a third smaller cyclone generated as a result of the nozzle. The original prior art vacuum did not include such a novel nozzle but included a nozzle that is normally used in vacuum cleaners where the air travels parallel to the extension of the vacuum hose, as opposed to substantially perpendicular therefrom. As a consequence the improved unit provides for air flow that essentially wipes the inside of the dust bin 20 and also the filter cover 41, that is the pre-filter fine mesh. This wiping action also encourages the suspension of the air in the dust bin and keeps the vacuum hovering for a much longer period of time.

In tests conducted with the prior art and current improvements initially at start up a pressure of 100 psi was achieved with a very similar fan to AIRIDER indicating that there is less pressure drop across the filter system. After operation the pressure dropped to about between 90 and 92 psi as compared to the AIRIDER system which started at 80 psi and dropped down to about 56 psi where the AIRIDER stopped hovering. The improved current unit did not stop hovering. The main reason for this is the hanging basket filters or pocket filters 42 that provides for the balling up of the dirt because of the cyclonic action in the filter system and the motion of air from the sides and below the pocket filter 42 which rolls over the dirt and eventually rolls it over into balls. The sediment therefore aggregates with any carpet fibres being vacuumed up. This action further enhances the operation of the vacuum cleaner.

After operating the vacuum it was disassembled and an inspection was made. It was noted that the fibreglass 1/16 inch pre-screen 41 was in fact clear being only for coarse filtering. Therefore because of the cyclonic action the coarse particles remained in the dust chamber. When the pre-screens were removed from the suspending flange the pocket filter 42 were inspected and it is noted that any dirt within the hanging pocket filters 42 had balled up and didn't penetrate to the charcoal pre-filter for the HEPA filter or the HEPA filter to any great extent. Once the dirt balls up together in the hanging pocket filter 42 essentially it won't separate and pass through the filter. The air circulating around and beneath the hanging pocket filter 42 creates this balling effect between the dust and the carpet fibres being vacuumed and collected.

The hanging pocket filter 42 is made from material that will pass 220 CFM so it is standardized at much greater level than the actual fan motor itself at 90 CFM. The motion of air through the filters as discussed above provides the unique handling ability of the hovering vacuum 10 to keep itself clean and maintain its hovering capability.

Further when the filter housing 40 is inspected, the filter housing base 46 that carries the pocket filters 42 and the HEPA filters when the pre-filters 41 are removed, the pocket filters 42 are removed, the actual filter housing base 46 remained considerably cleaner and more or less dirt free. The HEPA filter in the current system is protected by a pre-filter 47a which is a charcoal filter on the suction side of the fan and of the HEPA filter 47 and although slightly fouled prevents dirt from passing into the HEPA filter. In keeping the HEPA filter 47 clean this allows the vacuum to hover for a much longer period and keeps the motor clean without tripping the breaker such as in the case of the AIRIDER original system which cut out electrically.

One of the very important attributes of the current improvements is the unique nozzle design 30 and essentially the construction of the nozzle. This is made using the suppliers hose and with a unique adaptor provided at the end of the current hose. At the end of the hose, a hose cuff 3 is provided made from semi-rigid plastic attached to the supplier's hose 14. This hose cuff includes a radius joint which allows for assembly of the hose cuff with the current nozzle construction as described above. It is important that this hose cuff deflect and it should be made from this semi-rigid plastic that would be sufficient to deflect to allow the rib on the hose cuff to connect with and mate with the current nozzle.

The current nozzle 30 also is made to include an internal hose cuff locking feature that expands and compresses and locks into place with a hose cuff 3 as seen in FIGS. 4 and 5. It is intended that the cuff and the nozzle would be made in an assembly that is a two shot moulding process. The top section of the nozzle includes a tetrapolyethelene which a hardness between 79 and 89 and has a similar construction to the hose cuff. Below that top section is a material that's made from semi-rigid plastic allowing the whole section to deflect being slightly harder than the hose cuff material. Below that section is a collar 35 which surrounds the opening in the dust bin and acts as a seal and below that section there is provided nozzle 30 the part that is rigid and made from rigid plastic so as not to deflect under air pressure. The entire unit will be moulded in one piece or assembled as one piece with the cut out 36 for the air extending substantially perpendicular to the extension of the hose H at the bottom of the nozzle 30 and includes a blunt face end 36a to cause the air to move in a perpendicular direction and cause a turbulent action in the dust bin 20.

The tetrapolyethelene includes a rubber additive that accommodates the hole opening in the dust bin 20. The nozzle 30 will therefore lock in place in cuff 3 and yet be free to swivel 360 degrees as the user is vacuuming the flooring being cleaned.

At the bottom (see FIG. 11) of the actual vacuum unit as previously described there is provided a unique footprint which provides for improvement of the air flow in the air channel 18 which is balanced with the air flow from the fan providing for more effective hovering of the hovering vacuum over ceramic and tile floors. As can be seen from inspecting that footprint of FIG. 11 and FIG. 1 the motor and the opening for the air flow on the bottom of the footprint is off center toward the rear of the unit. The channel passes air around the base but the channel stops near the end of the vacuum cleaner 10 to retain the air in position and improve the hovering performance of the current unit. The motor 8 is set to be off center from the center of gravity of the vacuum unit 10 to accommodate for the weight of a user pulling the vacuuming hose at the front and to allow for a more consistent hovering of the unit. The channel 18 includes a discontinuity near the rear as stated above and provides for matching air flow in the channel as with the CFM of the fan (90 CFM minimum).

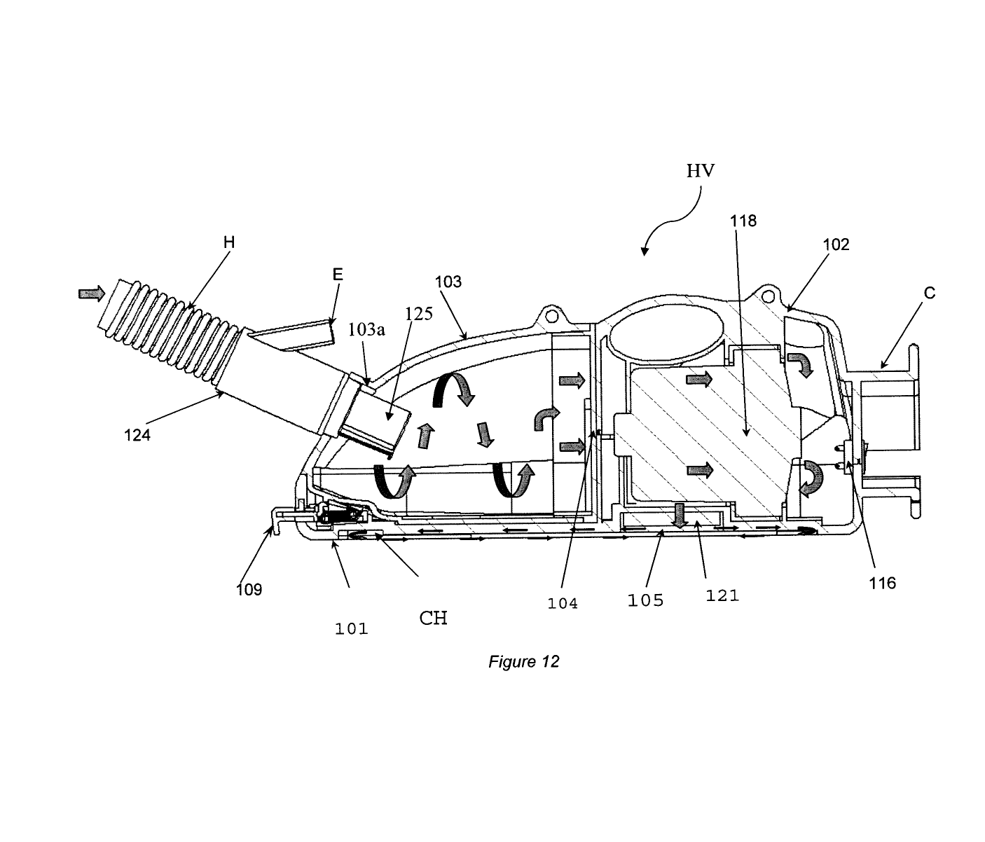

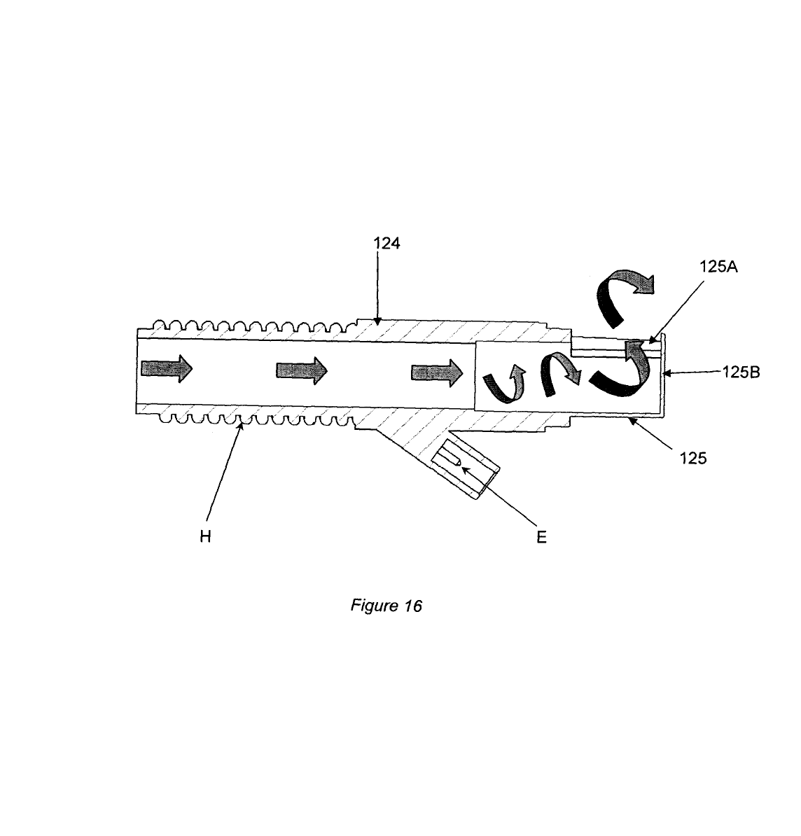

Referring generally to the FIGS. 12-24 there is illustrated a compact hovering vacuum cleaner HV including a top and bottom, front and rear. This vacuum is designed to hover over surfaces being cleaned and easily move on those surfaces. Typically the surfaces being cleaned include carpet, hardwoods, laminate, linoleum and tiling.

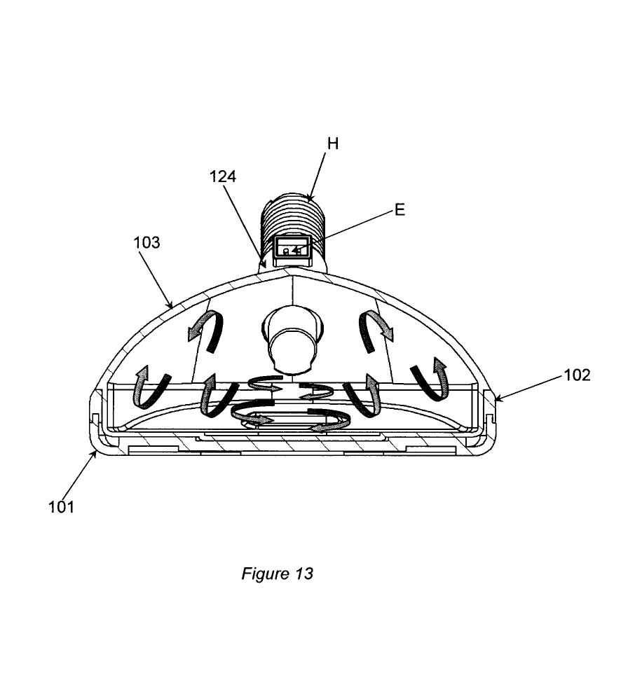

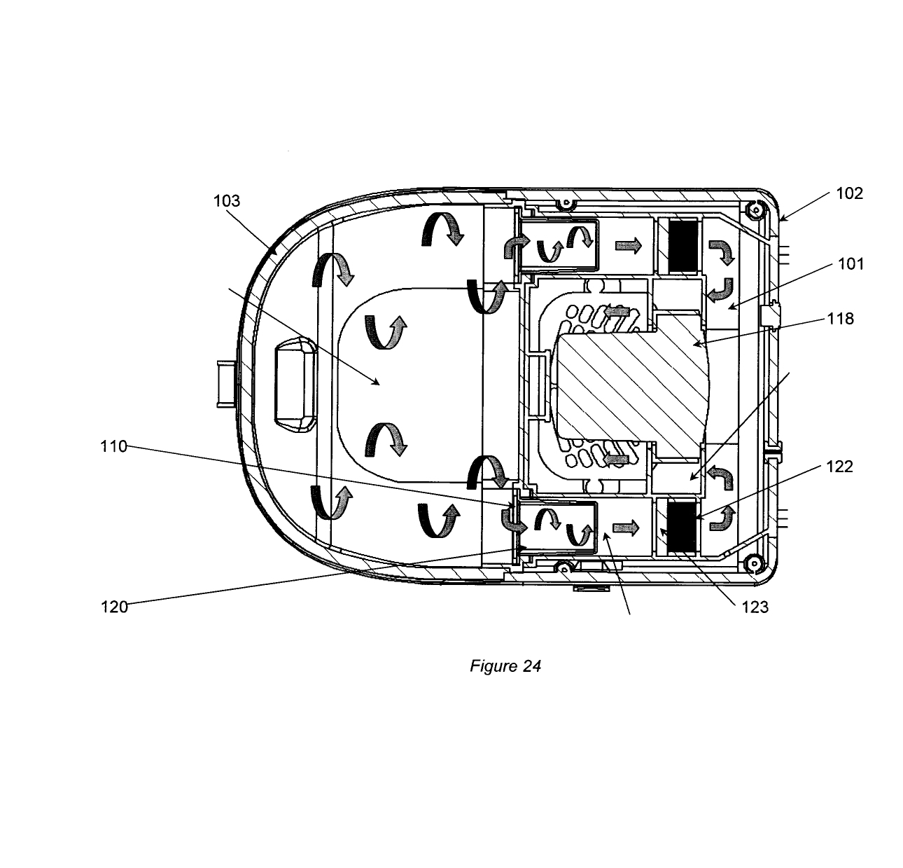

The present hovering vacuum cleaner has a dust bin 103 provided near the front thereof which includes an opening 103a adapted to accommodate a hose H having a nozzle 124 and a spout portion 125 engage with opening 103a in use. As best seen in FIG. 116 air exiting the nozzle does so at right angles through opening 125a in said spout 125. By providing this perpendicular airflow this action generates a cyclonic motion in the dust bin as is best seen in FIG. 13 and FIG. 24. The dust bin is removable from the vacuum cleaner shell 102 of the vacuum assembly HV.

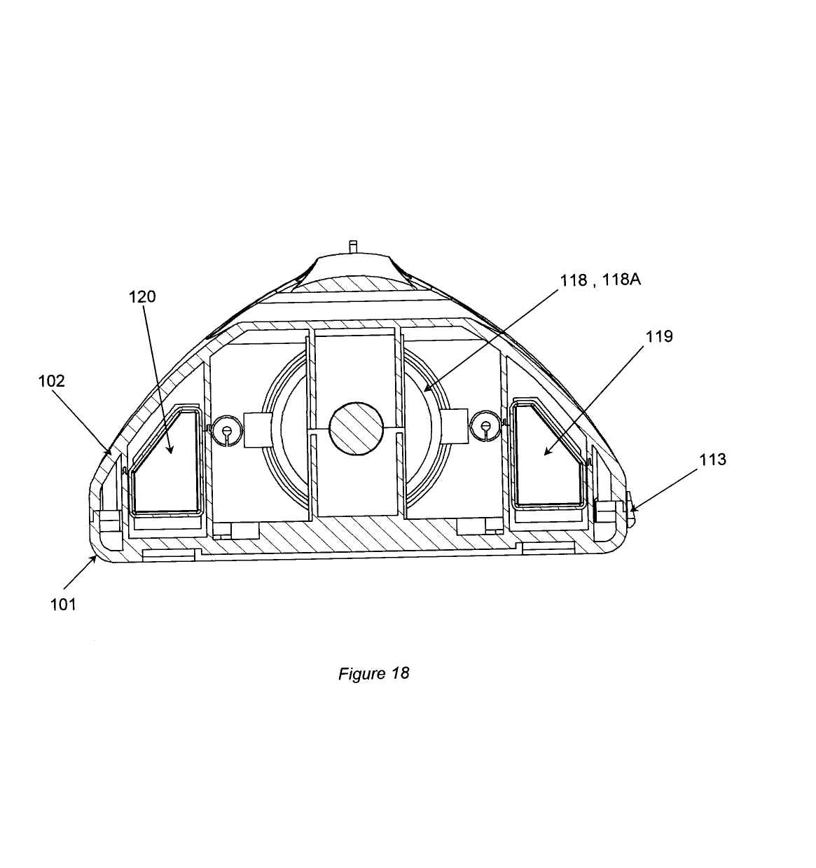

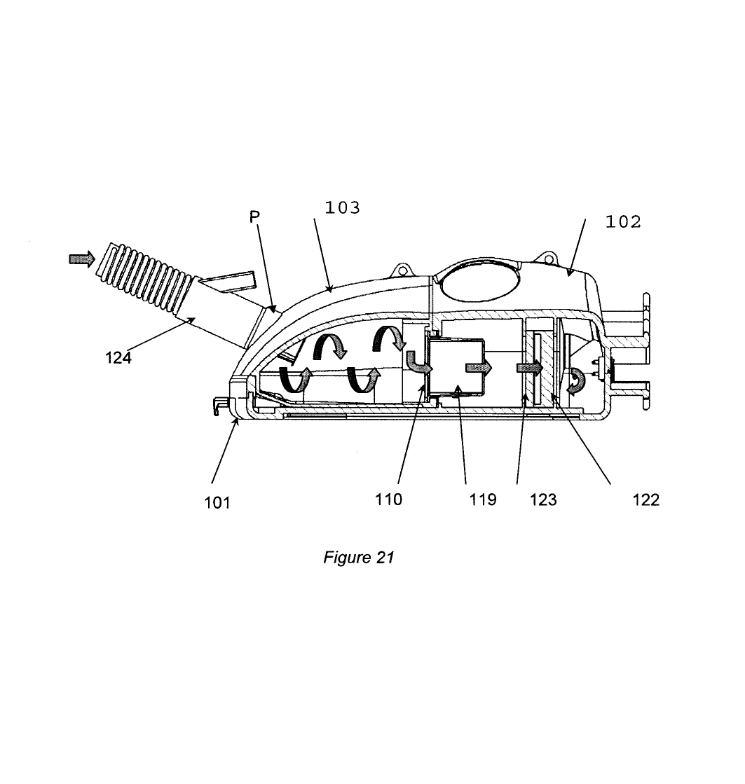

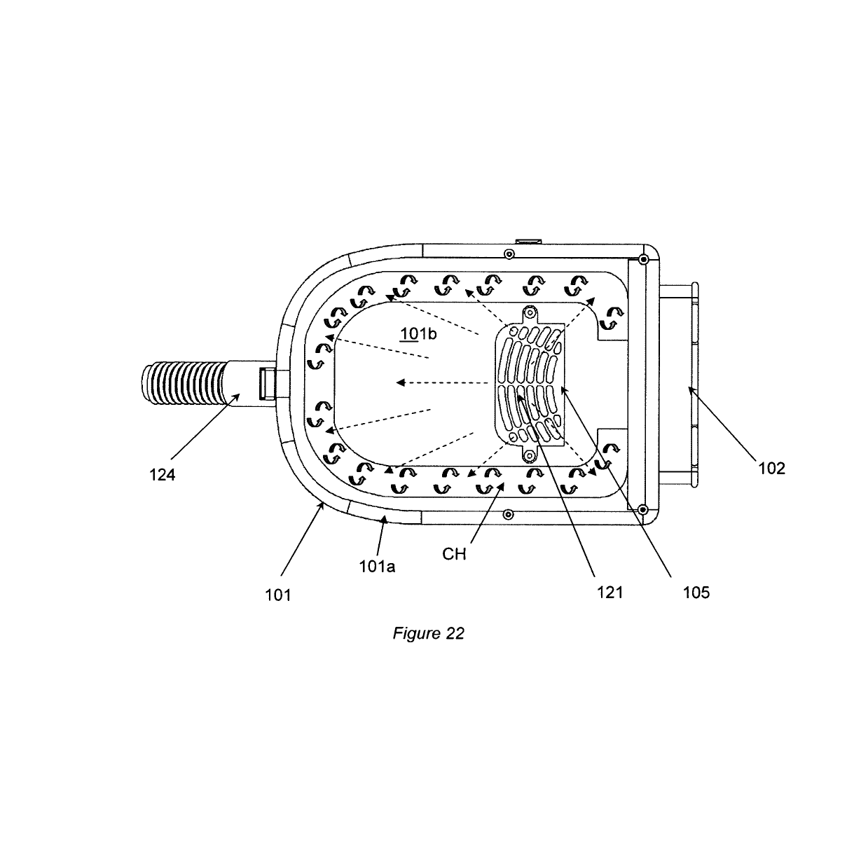

Referring specifically to FIG. 12 the compact vacuum cleaner HV is illustrated in side view. The vacuum cleaner includes a base 101 at the bottom thereof and a shell 102 enclosing all of the components of the vacuum cleaner HV. Located at the front of said vacuum cleaner is a removable dust bin 103 wherein dirt and dust accumulate until such time as the bin 103 must be emptied. Air therefore will enter the dust bin 103 and move through to a filter system enclosed within the shell 102 of the vacuum cleaner HV. A fan which is adjacent a drive motor (both of which are conventional) labeled as 118 and 118a in FIG. 18, provide the air circulation required for operation of the vacuum. The air therefore as best seen in FIG. 21 is drawn through port P located at the front of the vacuum cleaner dust bin 103 and then it moves in a cyclonic action within the dust bin passing through preliminary filter 110 and 111 to a pocket filter 119 and 120 then through charcoal filter 123 and the cartridge filter 122 which is a HEPA filter. The air will move through each of these components in succession and ultimately be exhausted through a base filter 121 and the exhaust cover as is best seen in FIG. 12. As a result filtered air which has been substantially cleaned through the filtering process of the vacuum cleaner HV passes on to the air handling circuit disposed at the bottom of the base 101 of the vacuum cleaner including a channel CH best seen in relation to FIG. 22 which traps the filtered air for a period of time and thereby provides a curtain of air upon which the hovering vacuum cleaner will hover. The air movement therefore of the vacuum cleaner not only provides a means of vacuuming up dirt from the surface being cleaned but also provides the ability of the vacuum cleaner to move laterally without the need of wheels, rollers or the like. As discussed in the background of the invention hovering vacuum cleaners are well-known but few have been successful in the marketplace because they cannot operate for extended periods of time successfully. The present invention is enhanced by the unique filtering ability of the vacuum cleaner in order to maximize the cycle time for the vacuum cleaner between cleanings yet being able to function fully in between the cleanings.

The vacuum cleaner HV includes a cord bracket C proximate the rear thereof to accumulate a power cord which will engage the vacuum cleaner at the electrical receptacle E provided with the vacuum hose as seen in FIG. 12. A power switch 116 is provided at the rear of the vacuum and a supplementary outlet 113 for a power head is also provided as well for those powered units that typically also agitate a carpet being cleaned.

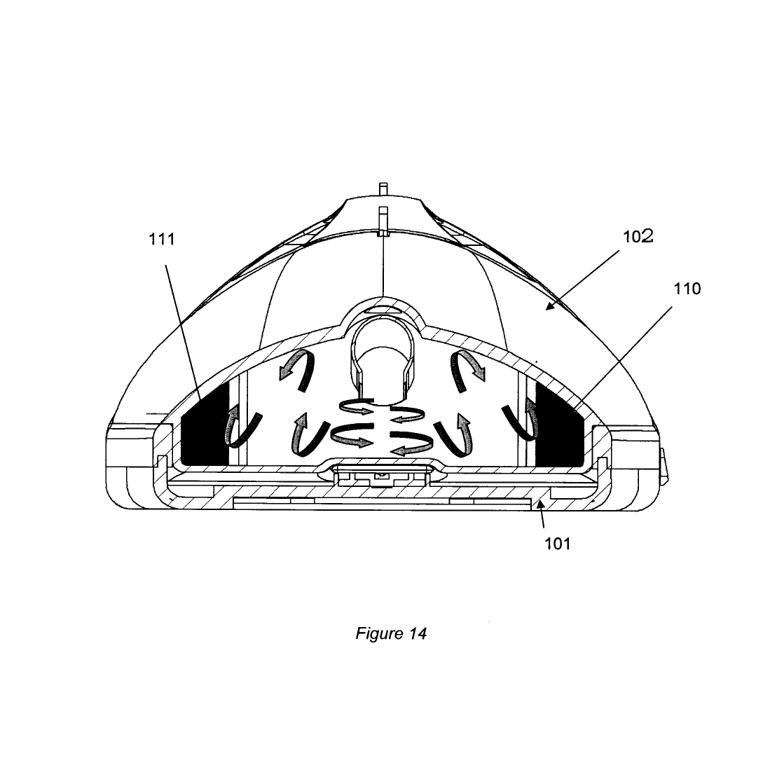

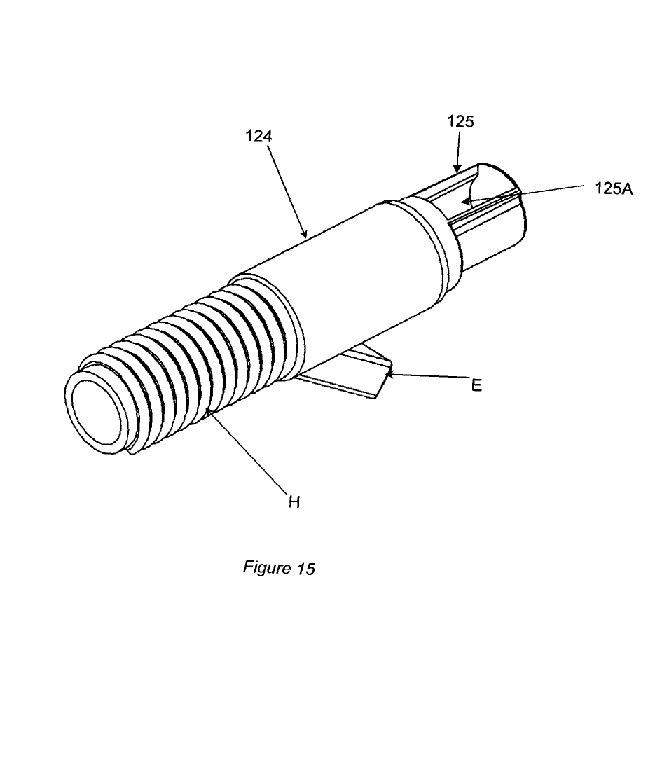

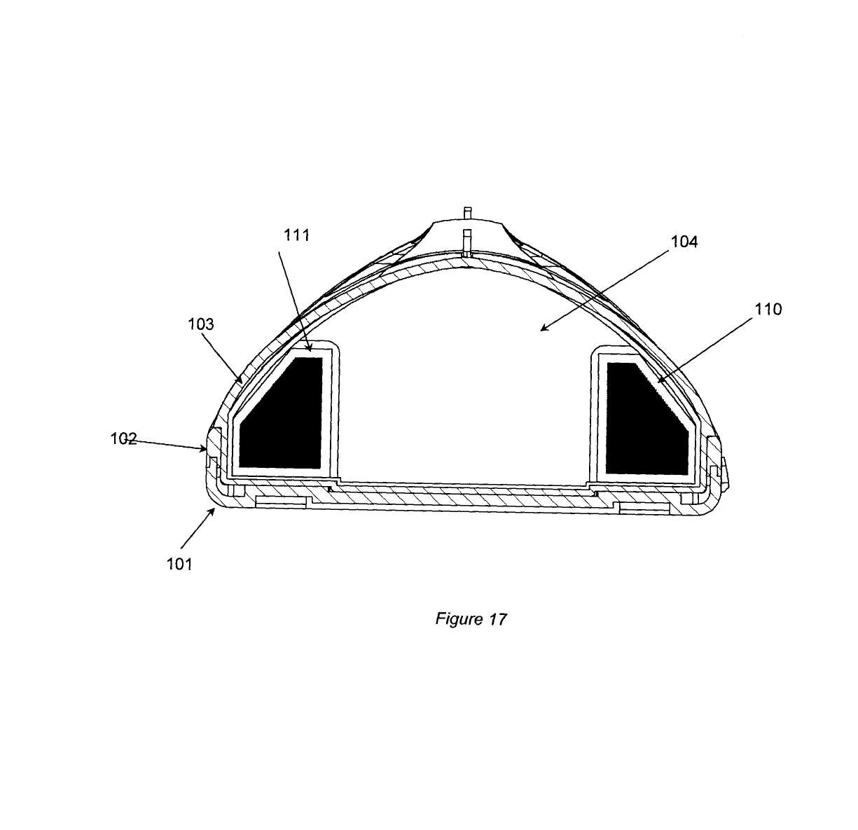

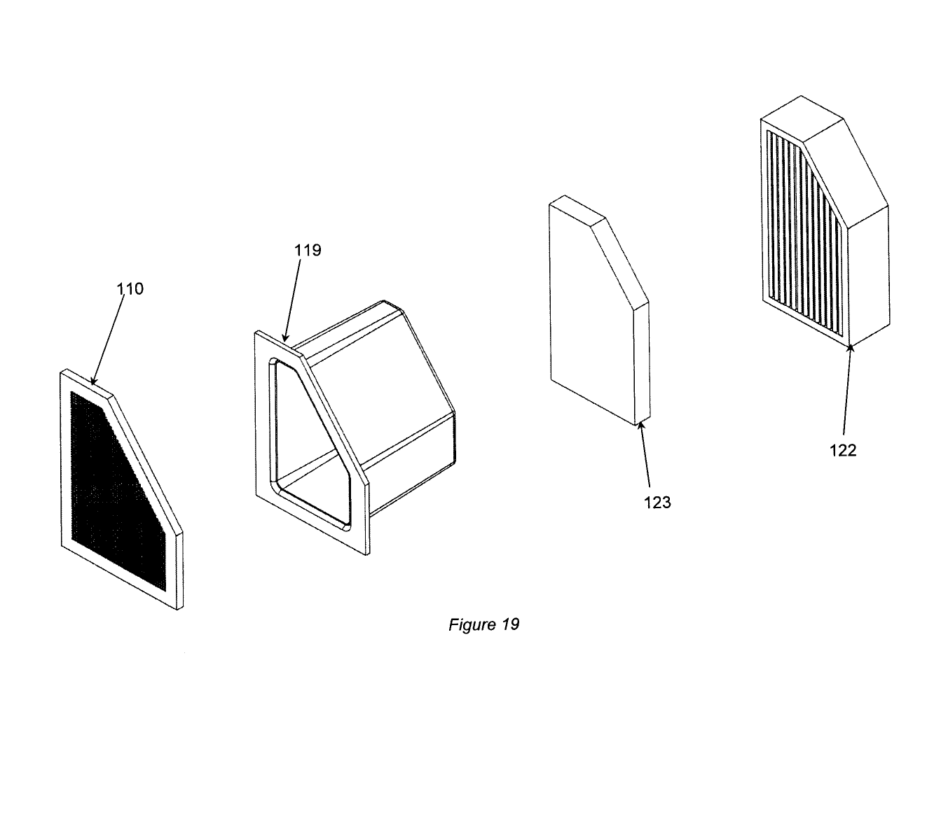

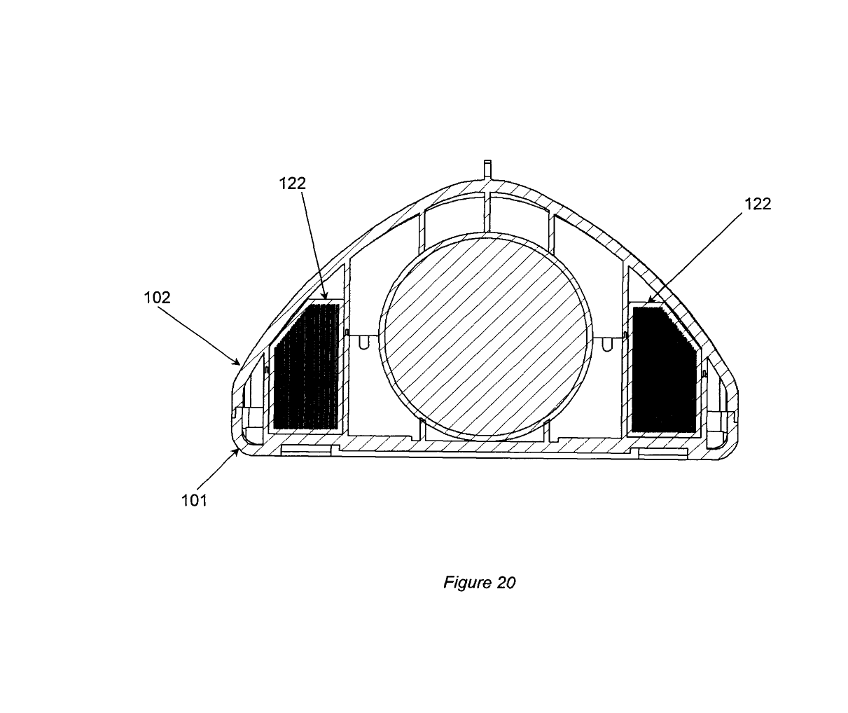

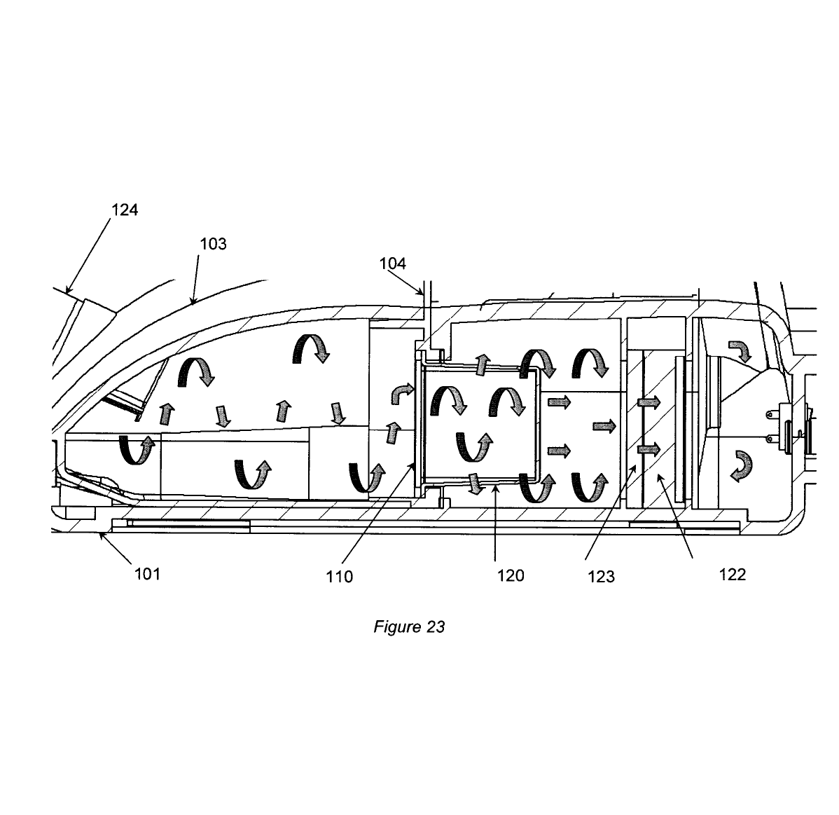

As best seen in FIG. 12 a removable dust bin 103 engages the remaining shell portion 102 of the compact vacuum HV adjacent the backing plate 104 behind which are located of the compact vacuum HV adjacent the backing plate 104 behind which are located a drive motor and fan as best seen in FIG. 17. The backing plate 104 also houses a pre-filter 110 and 111 there-within which begins the process of filtering for the vacuum cleaner HV. As best seen in FIG. 14 the cyclonic motion of the air generated by the nozzle in the dirt bin 103 also wipes the face of the dirt bin interior as well as the face of pre-filters 110 and 111 to prevent large particles of dirt being accumulated thereon. The cyclonic pattern generated includes essentially two oppositely swirling cyclones and a third vertically swirling cyclone provided by the dirt bin 103 and nozzle assembly 124 of the vacuum hose H and specifically the spout 125 as best seen in FIG. 15. The spout 125 includes a cut out 125a which directs air moving through the vacuum hose H through the nozzle 124 and the spout 125 at right angles to the extension of said nozzle 124 and thus in co-operation with the dust bin 103 results in the cyclonic motion of the air shown in FIG. 13. By providing a cyclonic motion as shown, air will move and circulate in the dust bin to ensure that large particles and clumps of dust will swirl and remain in motion without settling within the dust bin. This action enhances the lifecycle and vacuuming ability of the hovering vacuum HV. The air continues to move through the vacuum cleaner wiping the faces of the pre-filters 110 and 111, as discussed in relation to FIG. 14 and moves through the backing plate 104 into pocket filters 119 and 120 provided as best seen in relation to FIG. 18. The pocket filters 119 and 120 as best seen in FIG. 19 are made from polypropylene point bonded media, two ounce point bond, permitting an air flow of 220 ft.³ per minute. This pocket assembly is made of rigid foam and is die-cut then formed and then subsequently ultra sonically welded to a plastic frame to provide the necessary support as seen in FIG. 19. The pocket filters 119 and 120 will therefore fit within the cut outs as shown in FIG. 18. Subsequent to the pocket filter a charcoal filter 123 is provided adjacent to a HEPA filter 122 as seen in FIG. 19 and FIG. 20. Air will therefore move through the vacuum cleaner and the filter system as best seen in FIG. 21 and more specifically in FIG. 23. The air therefore will wipe the face of the pre-filter 110 and will therefore tend to swirl the fine particles to encourage a balling effect and enhance air airflow performance within the pocket filter's 119 and 120. Air will therefore circulate around the perimeter of the pocket filter as well as within the interior thereof which encourages any dirt to ball up which can be held in suspension both in the dust bin 103 and in the pocket filter 119 and 120. The air will then pass as best seen in FIG. 23 through the charcoal filter 123 which provides for fine filtering for the cartridge filter 122, preferably a HEPA filter.

The vacuum HV therefore includes a filtering process which filters initially the coarsest of particles, then the intermediate particles within the pocket filter, then finer particle yet again in the charcoal filter 123, and finally the smallest of particles within HEPA filter 122. Filtered air will therefore exit the filter assembly primarily contained within the center portion of the vacuum and pass on to the base 101 as best seen in relation to FIGS. 22 and 24. Cleaned air therefore passes through the base filter 121 and cover 105 to the channel portion CH disposed on the bottom of the base off the vacuum cleaner HV to provide a cushion upon which the vacuum cleaner HV hovers over a surface being cleaned. The channel portion CH is defined by a perimeter portion 101a and a central portion 101b seen in FIG. 22. For airflow purposes the central portion 101b is at a different height than the perimeter portion 101a of the base 101 and the channel CH is substantially horseshoe shaped and is discontinuous proximate the rear of the base. The perimeter portion 101a of the base 101 and the central portion 101b of the base 101b define their between the horseshoe shaped channel CH of a predetermine depth which is sized in volume to balance with the air output (at predetermined CPF) from the fan provided with the compact floating vacuum cleaner HV.

Referring now to FIG. 24 a detailed view is shown of the bottom of the vacuum cleaner as a schematic to illustrate the airflow from the nozzle 124 and the spout 125 into the dust bin 123, through the filter assembly, through the base and on to the generally horseshoe shaped channel disposed on the bottom of the base 101. In providing a hovering vacuum cleaner HV of this design many of the problems associated with prior art unit have been overcome such as elimination of the fouling of the prior art filter systems and the subsequent imbalance of hovering of the vacuum unit, which is impossible when the air circulation is hampered and not operating at a steady state.

In terms of material is used in the construction of the hovering vacuum cleaner HV as discussed above the pocket filter which is a critical portion for the assembly is made from polypropylene point bonded media providing for airflow of about 220 cubic feet per minute. Alternative materials might be used as well without the departing from the scope of the invention. The pre-filter is made from 1000 micron diecut nylon monofilament mesh secured within the opening to the backing plate 104 by conventional means. The HEPA filter and the charcoal filter are made from conventional materials. The motor and fan selected for use within the vacuum cleaner may be any conventional motor and compatible fan which correctly operates the compact hovering vacuum HV. One skilled in the art should be able to determine requirements of the motor but it is suggested that one providing 1100 W of power would be sufficient. All the components will be molded in use according to underwriters laboratory UL and CSA approved materials. As a result a more compact hovering vacuum cleaner HV is provided than conventional designs as illustrated by those in the prior art. The new footprint for the base including the horseshoe shaped channel eliminates the need for a skirt around the base previously used and provides many improvement to the hovering feature for the vacuum cleaner resulting in a user-friendly light weight design, yet while maintaining overall performance of the vacuum cleaner with respect to suction, mobility and over all cleaning power. Further there is a weight and size reduction of the unit as a result of the present design from those units known in the prior art to enable those that are unable to carry about heavier equipment the luxury of owning a high-performance unit and to find adequate storage space therefore.

In order to clean the filter system for the hovering vacuum HV once the operation thereof ceases the pre-filters 110 and 111 are removed from the backing plate 104 and cleaned. An opening therefore as a result is available through the backing plate permitting access to the pocket filters 119 and 120 which are easily removed and cleaned. The charcoal filter and a HEPA filter can be reached from and through the opening in backing plate 104. All of the filtering components should be inspected and cleaned and subsequently returned to their proper positions in the unit prior to starting the unit up again.

The vacuum hose H may be provided with or without a convenient swivel proximate the spout 125 of the nozzle assembly 124. A seal is also provided therewith which seals within the opening P of the dust bin 103 to enhance the vacuum suction capability of the hose.

A handle portion, which is unlabeled, is provided integral with the shell 102 to permit a user to carry the hovering vacuum cleaner HV to and from storage locations. The cord bracket C is also integral with the shell 102 to allow for a power cord to be accumulated thereupon prior to storage and to remain conveniently accessible to the user.

Referring to FIGS. 22 and 24 together in concert clearly it can be seen that the unique construction of the base provides for an air circuit from the exhaust port around a center island portion in the base to the channel portion, the base surrounded by the perimeter portion and the base 115. It is noted that the channel portion has a discontinuity adjacent the end thereof which discontinuity includes the extension of the center island portion to the rim portion. Air will therefore travel from the exhaust port along the island portion which has a different height than then the perimeter portion and subsequently to the channel which has a further different height to allow a unique cushion of air to be provided upon which the vacuum may hover. As previously mentioned the air handling circuit should be balanced with the fan speed and be provided with at least 90 CFM of air to permit reliable hovering.

At the bottom (see FIG. 22) of the actual vacuum unit as previously described there is provided a unique footprint which provides for improvement of the air flow in the air channel which is balanced with the air flow from the fan providing for more effective hovering of the hovering vacuum over ceramic and tile floors. As can be seen from inspecting that footprint of FIG. 22 and FIG. 23 the motor and the opening for the air flow on the bottom of the footprint is off center toward the rear of the unit. The channel passes air around the base but the channel stops near the end of the vacuum cleaner to retain the air in position and improve the hovering performance of the current unit. The motor is set to be off center from the center of gravity of the vacuum unit to accommodate for the weight of a user pulling the vacuuming hose at the front and to allow for a more consistent hovering of the unit. The channel includes a discontinuity near the rear as stated above and provides for matching air flow in the channel as with the CFM of the fan (90 CFM minimum).

As many changes therefore may be made to the preferred embodiment of the invention without departing from the scope thereof. It is considered that all matter contained herein be considered illustrative of the invention and not in a limiting sense.

1-39. (canceled)

40. A vacuum cleaner hose comprising two ends, a first end for engaging a surface vacuuming apparatus, and a second end for engaging a vacuum cleaner, said second end of said vacuum cleaner hose terminating in a hose cuff and a nozzle connected thereto and for engaging the opening in a dust bin of the vacuum cleaner, said nozzle including two extremities and having disposed proximate a first extremity a nozzle top section that engages the hose cuff disposed proximate the second end of the vacuum hose by the provision of a locking detent which engages and locks with a corresponding locking detent provided with the hose cuff permitting swiveling of the nozzle with respect to the hose cuff while securing the nozzle in position with respect to the vacuum hose, said nozzle including a nozzle spout at a second extremity thereof that engages the opening in the dust bin of the vacuum cleaner, and made of rigid material such as rigid plastic so as not to deflect under pressure, said nozzle top section and said nozzle spout having disposed there-between a nozzle collar for sealing the opening in the dust bin of said vacuum cleaner, said nozzle spout including an air outlet disposed substantially perpendicular to the axis of extension of said nozzle and also including an end cap portion proximate the end thereof which turns the direction of the air flow from the vacuum hose to a direction substantially perpendicular to the axis of the nozzle, wherein air exiting said nozzle spout and passing into said dust bin of a vacuum cleaner generates cyclonic action in the dust bin, as a result of turbulence created by turning the air exiting the nozzle spout of the vacuum hose.

41. The vacuum cleaner hose of claim 40 wherein said nozzle collar also has a sealing flange disposed proximate the perimeter thereof adjacent said nozzle spouts for sealing about the external perimeter of the dust bin opening.

42. A nozzle of claim 40 comprising two extremities and having disposed at the first extremity a nozzle top section made from semi-rigid plastic resin that engages a hose cuff disposed proximate an end of a vacuum cleaner hose also made from semi-rigid plastic resin said nozzle top section including a locking detent for engaging and locking with a corresponding locking detent provided with the hose cuff permitting swiveling of the nozzle with respect to the hose cuff of the vacuum cleaner hose while securing the nozzle in position with respect to the vacuum cleaner hose, said nozzle also including a nozzle spout proximate a second extremity thereof that engages an opening in a dust bin of the vacuum cleaner, said nozzle spout being made of rigid material such as rigid plastic so as not to deflect under pressure, said nozzle top section and said nozzle spout having disposed there-between a nozzle collar, made from a thermoplastic elastomer, for sealing the opening in a dust bin of a vacuum cleaner, said nozzle collar also having a sealing flange disposed proximate the perimeter thereof adjacent said nozzle spout for sealing about the external perimeter of the dust bin opening, said nozzle spout including an air outlet disposed substantially perpendicular to the axis of extension of said nozzle and also includes an end cap portion at the end thereof which turns the direction of the air flow exiting the vacuum hose in a direction substantially perpendicular to the axis of the nozzle, wherein air exiting said nozzle spout and passing into said dust bin of a vacuum cleaner generates cyclonic action in the dust bin, as a result of turbulence created by turning the air exiting the nozzle spout of the vacuum cleaner hose.

43. A hovering vacuum cleaner comprising: a front and rear, a top and bottom, said vacuum cleaner having a base disposed proximate the bottom thereof, said base also having a top and bottom, said vacuum cleaner carrying a fan for moving air through said vacuum cleaner, said base having disposed proximate the bottom thereof an air handling circuit to permit the vacuum cleaner to hover over a surface being vacuumed on a cushion of air provided by said fan, said vacuum cleaner including an exhaust port passing through said base in communication with the air handling circuit, the air passing through the exhaust port to the air handling circuit, said air handling circuit being defined by a perimeter portion of said base extending around the perimeter of the bottom of said base, a central portion disposed proximate the middle of said base containing said exhaust port and disposed at a height above said perimeter portion of the bottom of said base, and a channel portion disposed between said perimeter portion and said central portion at a height above the central portion and at a predetermined channel depth, said channel portion substantially circumscribing said base but being discontinuous proximate the rear of said vacuum cleaner base, whereat the central portion extends to the perimeter portion, wherein said air handling circuit is sized to substantially balance with the volume of air being moved by said fan through said vacuum cleaner and thus providing improved hovering capability of said vacuum cleaner as air passes from said exhaust port over said central portion and about said channel portion thus providing a cushion of air upon which said vacuum cleaner hovers.

44. The hovering vacuum cleaner of claim 43 wherein said exhaust port is disposed offset from the middle of said base at a height above said perimeter portion.

45. A filter assembly for a vacuum cleaner comprising a bottom and side portions, a pocket filter support within said filter assembly for supporting a pocket filter, a pocket filter supported by supporting portions of said pocket filter support and engaging flanges disposed proximate the top of said pocket filter, wherein the pocket filter is supported in an operating position by said pocket filter support while not allowing said pocket filter to touch the bottom and sides of the filter assembly thereby providing an air space disposed between the pocket filter and the filter assembly bottom and side portions to provide for circulation of air and allow the creation of turbulence in the air space to encourage any dust accumulating in the pocket filter to remain in motion and to ball up to thus improve the efficiency and effectiveness of the filter assembly of the vacuum cleaner.

46. The filter assembly of claim 45 wherein said pocket filter support has disposed proximate the top thereof, above said pocket filters, supplementary screens, to provide coarse filtering for the filter assembly.

47. The filter assembly of claim 46 having disposed after said pocket filters a HEPA filter member.

48. The filter assembly of claim 47 wherein said HEPA filter member has disposed proximate the exterior thereof adjacent said pocket filter a carbon charcoal filter to protect the HEPA filter member in use, the entire filter assembly being removably disposed within the dust collection chamber of the hovering vacuum cleaner.

49. A pocket filter support within a filter assembly of claim 48 for supporting a pocket filter, a pocket filter being supported in an operating position by said pocket filter support engaging with flanges disposed proximate the top of said pocket filter, said pocket filter support not permitting said pocket filter to touch the filter assembly and thereby providing an air space disposed between the pocket filter and the filter assembly to provide for circulation of air and allow the creation of turbulence in the air space to encourage any dust accumulating in the pocket filter to remain in motion and to ball up to thus improve the efficiency and effectiveness of the filter assembly.

50. The filter assembly of claim 45 wherein said filter assembly within the dust chamber of a hovering vacuum cleaner in conjunction with a unique nozzle with an air outlet disposed substantially perpendicular to the axis of said nozzle, provides a cyclonic action within the dust chamber which in operation keeps the air and the dust substantially in circulation in the dust chamber to reduce the load on the filter assembly.

51. The filter assembly of claim 50 wherein by wiping the filter assembly with circulating air and encouraging the dust to ball up in the dust chamber by the provision of cyclonic action therein vastly improves the life of said filter assembly and the lift of said hovering vacuum cleaner.

52. A hovering vacuum cleaner comprising: a front and rear, a top and bottom, said vacuum cleaner having a base disposed proximate the bottom thereof, said base also having a top and bottom, said vacuum cleaner carrying a fan for moving air through said vacuum cleaner, said base having disposed proximate the bottom thereof an air handling circuit to permit the vacuum cleaner to hover over a surface being vacuumed on a cushion of air provided by said fan, said vacuum cleaner including an exhaust port passing through said base and in communication with the fan and the air handling circuit, the air passing from the fan through the exhaust port to the air handling circuit, said air handling circuit being defined by a perimeter portion of said base extending around the perimeter of the bottom of said base, a central portion disposed proximate the middle of the bottom of said base containing said exhaust port and disposed at a height above said perimeter portion of the bottom of said base, and a channel portion disposed between said perimeter portion and said central portion at a height above the central portion and at a predetermined channel depth, said channel portion substantially circumscribing the bottom of said base but being discontinuous proximate the rear of said vacuum cleaner base whereat the central portion extends to the perimeter portion, wherein said air handling circuit is sized to substantially balance with the volume of air being moved by said fan through said vacuum cleaner and thus providing improved hovering capability of said vacuum cleaner as air passes from said exhaust port over said central portion and about said channel portion thus providing a cushion of air upon which said vacuum cleaner hovers.

53. The hovering vacuum cleaner of claim 52 wherein said exhaust port is disposed offset from the middle of said base at a height above said perimeter portion.

54. A filter assembly for a vacuum cleaner comprising a pocket filter within said filter assembly, the pocket filter being supported by supporting portions of a pocket filter frame engaging flanges disposed with said pocket filter, wherein the pocket filter is supported in an operating position by said pocket filter frame while not allowing said pocket filter to touch the bottom and sides of the filter assembly thereby providing an air space disposed between the pocket filter and filter assembly bottom and side portions to provide for circulation of air and allow the creation of turbulence in the air space to encourage any dust accumulating in the pocket filter to remain in motion and to ball up and to thus improve the efficiency and effectiveness of the filter assembly of the vacuum cleaner.

55. The filter assembly of claim 54 wherein said pocket filter has disposed therewith supplementary screens to provide coarse filtering for the filter assembly.

56. The filter assembly of claim 55 having disposed after said pocket filters a HEPA filter member.

57. The filter assembly of claim 56 wherein said HEPA filter member has disposed proximate the exterior thereof adjacent said pocket filter a carbon charcoal filter to protect the HEPA filter member in use.

58. The filter assembly of claim 57 wherein said filter assembly is adjacent the dust chamber of a hovering vacuum cleaner and in conjunction with a unique nozzle with an air outlet disposed substantially perpendicular to the axis of said nozzle, provides a cyclonic action within the dust chamber which in operation keeps the air and the dust substantially in circulation in the dust chamber to reduce the load on the filter assembly.

59. The filter assembly of claim 58 wherein wiping the surfaces of the filter assembly with circulating air encourages the dust to ball up in the dust chamber by the provision of cyclonic action therein vastly improving the life of said filter assembly and the lift of the hovering vacuum cleaner.
